(19) United States
(12) Patent Application Publication
(10) Pub. No.: US 2024/0104555 A1
(43) Pub. Date: Mar. 28, 2024

(54) USER-CONTROLLED CURRENCY CONVERSION SYSTEM AND METHOD

(71) Applicant: SteamChain Corp., Beaverton, OR (US)

(72) Inventors: Dan Biggs, Salem, OR (US); Scott Brown, Beaverton, OR (US); Charles Jennings, Portland, OR (US)

(21) Appl. No.: 17/768,832

(22) PCT Filed: Aug. 31, 2020
(86) PCT No.: PCT/US2020/048837

§ 371 Date: Apr. 13, 2022

(51) Int. Cl. G06Q 20/38; G06Q 30/0202; G06Q 40/04

(52) U.S. Cl. CPC G06Q 20/381; G06Q 20/389; G06Q 30/0202; G06Q 40/04; G06Q 2220/00

(57) ABSTRACT

Illustrative embodiments include methods, and corresponding systems, that leverage cryptocurrency and blockchain technology to provide user-controlled, secure and rapid currency conversion and currency exchange between parties. Illustrative embodiments convert funds denominated in a source currency to a cryptocurrency, and then convert the cryptocurrency to funds denominated in a destination currency.

### TECHNICAL FIELD

The present disclosure relates to currency conversion and, more particularly, to systems for implementing currency conversions.

### BACKGROUND ART

Currency exchange transactions are a crucial, yet expensive, part of the global shipping and logistics market. Fees taken for currency conversion in large transactions typically cost 5-10% of the total transaction amount. In addition, such transactions create a recordkeeping burden that increases overhead and slows commerce. Existing currency conversion options for internal company supply chain managers and third-party logistics vendors also fail to deliver currency fluctuation risk mitigation.

Consider, for example, an international supply chain. The global supply chain is long. There are numerous paper records, invoices, currency conversions, bills of lading, customs documentations and wire transfers associated with a single shipment. Currency exchange transactions are expensive, typically costing 5-10% of the total transaction amount. Existing currency conversion options for internal company supply chain managers and third-party logistics vendors also fail to deliver currency fluctuation risk mitigation.

In conventional, prior art transactions, currency conversions occur outside the core transaction processes among participating parties and require the services of a third-party currency conversion vendor or bank. The currency conversion process is lengthy, taking upwards of a week or more. Currently, banks charge a company requesting currency conversion for wiring fees and for the fees charged to the banks by currency conversion entities.

Additionally, conventional, prior art transactions, invoices are not subject to immediate payment, rather requiring payment within 30 or 60 days, for example. During the currency conversion process and the time before the invoice is due, currencies can fluctuate in value. Therefore, as the contracts are paid, the paying party may have overpaid or underpaid based on the currency fluctuations. This creates an almost endless loop whereby the parties are reconciling their ledgers to account for the differences between the contractual value and the value actually paid due to the currency fluctuation.

### SUMMARY OF VARIOUS EMBODIMENTS

A commission, which is based on blockchain, allows for quick execution (i.e. currency can be exchanged in seconds to minutes), is immutable, and is decentralized. Quick execution reduces or mitigates financial risk by minimizing currency fluctuations from execution to completion. Currently, there are no systems or methods that provide currency fluctuation risk mitigation, whether through a platform (e.g., commission), notifications (e.g., artificial intelligence, model-based learning), or both.

In accordance with an illustrative embodiment, a computer-implemented method for user-controlled currency conversion includes: obtaining, by a currency exchange platform, a commission for currency exchange between an initiator party and a recipient party, the commission including transaction data defining a proposed transaction; obtaining, by the currency exchange platform, access to source funds from the initiator, the source funds denominated in a source fiat currency; and providing, to the initiator party prior to execution of the proposed currency conversion transaction, a notification including an assessment of the proposed currency conversion transaction. The assessment based on currency market predictions which currency market predictions are based on: (i) a client policy profile; (ii) the transaction data; and (iii) current market data. The method also includes receiving from the initiator party, subsequent to the receipt by the initiator party of the notification, an instruction to execute the proposed transaction; executing the proposed currency conversion transaction defined by the commission for currency exchange. The execution includes converting, in a first conversion process, the source funds from the source fiat currency to a cryptocurrency; and subsequently converting, in a second conversion process, the cryptocurrency to recipient funds denominated in a destination fiat currency. The method then includes causing, by the currency exchange platform, transfer of the recipient funds to a recipient account, which recipient account is under control of the recipient party.

In some embodiments, the currency exchange platform recommends the cryptocurrency based on a combination of the source fiat currency and the destination fiat currency prior to executing the currency conversion transaction.

In some embodiments the currency exchange platform obtains access to the source funds from the initiator at a first time; and the currency exchange platform causes the transfer of the recipient funds to a recipient account at a second time subsequent to the first time; and wherein the source funds and the recipient funds are not held in an account of the currency exchange platform at any point in time between the first time and the second time.

In some embodiments, the method also includes, after obtaining the commission for currency exchange and prior to obtaining access to source funds from the initiator: sending, by the currency exchange platform, the commission to the recipient party for review; subsequently receiving, by the currency exchange platform from the recipient party, approval of the commission; and notifying, by the currency exchange platform, the initiator party that the recipient party has approved of the commission.

In some embodiments, obtaining the commission for currency exchange includes receiving, at the currency exchange platform, currency transaction information defining payment from the initiator to the recipient; and defining, by the currency exchange platform and based on the currency transaction information, the commission for currency exchange. In some such embodiments, receiving currency transaction information includes receiving specification of the source fiat currency; specification of a source amount denominated in the source fiat currency; specification of the cryptocurrency; specification of a source account holding the source funds; specification of a destination fiat currency; specification of the recipient account for receiving converted currency; specification of a crypto exchange; specification of a specified transaction speed; and/or specification of a specified time to send the commission to a recipient party.

In some embodiments, the method also includes, prior to executing the first conversion process: delaying the first conversion process; and subsequently receiving from the initiator an instruction to initiate execution of the first conversion process.

In some embodiments, the method also includes, prior to executing the first conversion process: generating, by the currency exchange platform, a notification to the initiator, the notification: including an assessment of the proposed user-controlled currency conversion transaction; and requesting from the initiator instructions to initiate execution of the currency conversion transaction. In some such embodiments, the notification is generated by an artificial intelligence based on at least one of market conditions, or conditions of the commission; and the assessment includes a qualitative assessment of the outcome of the currency transaction if the currency transaction were to be executed at the time indicated by the notification. In some embodiments, the notification is generated by an artificial intelligence based on at least one of market conditions, or conditions of the commission; and the assessment includes a recommendation of a point in time at which the currency transaction would be more beneficial for the initiator.

Another embodiment includes a computer-implemented artificial intelligence system including: an input configured to receive: (a) transaction data from a user, the transaction data defining a proposed user-controlled currency conversion transaction; and (b) current market data of a currency exchange market; an artificial intelligence configured to generate a set of real-time currency market predictions, the set of currency market predictions based on: (i) a client policy profile; (ii) the transaction data; and (iii) the current market data; an automated processor configured to produce, prior to execution of the currency conversion transaction and based on the currency market predictions, a notification including an assessment or (“analysis”) of the proposed user-controlled currency conversion transaction; and an output configured to provide the notification to a user.

Some embodiments also include a user interface configured to receive, prior to execution of the currency conversion transaction, user input to the artificial intelligence, the user input including one or more of: an amount of risk the client is willing to accept in the currency exchange transaction; a type of financial return desired by the client in the currency exchange transaction; an amount of financial return desired by the client in the currency exchange transaction; a cost of the currency exchange transaction acceptable to the client; a completion deadline for the currency exchange transaction; and/or a transaction duration, for the currency exchange transaction, acceptable to the client.

In some embodiments, the artificial intelligence is further configured to generate the set of real-time currency market predictions based on: (iv) transaction sampled data from prior currency exchange translations executed using the apparatus.

In some embodiments, the automatically-implemented artificial intelligence is configured by reinforcement learning (“RL”) according to the client policy profile, the client policy profile specifying a reward policy for the reinforcement learning process, the reward policy specifying at least one of: a set of goals desired by the client; and/or a set of conditions specified by the client for a currency transaction. In some such embodiments, the set of conditions includes any one or more of: an amount of risk the client is willing to accept in the currency exchange transaction; a type of financial return desired by the client in the currency exchange transaction; an amount of financial return desired by the client in the currency exchange transaction; a cost of the currency exchange transaction acceptable to the client; and/or a completion deadline for the currency exchange transaction; a transaction duration, for the currency exchange transaction, acceptable to the client.

In some embodiments, the apparatus also includes a user interface configured to receive, from the user, instructions regarding whether to execute the currency exchange transaction. In some such embodiments, the notification includes a proposed execution timing; and the user interface is further configured to receive, from the user, instructions regarding when at a future point to execute the currency exchange transaction.

In some embodiments, the currency exchange platform is further configured to generate a notification to the user, the notification: including an assessment of the proposed user-controlled currency conversion transaction; and requesting from the initiator instructions to initiate execution of the currency conversion transaction.

In some embodiments, the currency exchange platform is further configured to generate a notification to the user, wherein: the notification is generated by the artificial intelligence based on at least one of current market data, or conditions of a commission defining the controlled currency conversion transaction; and the notification includes a qualitative assessment of the outcome of the currency conversion transaction if the currency conversion transaction were to be executed at a time indicated by the notification. In some such embodiments, the qualitative assessment of the outcome of the currency transaction includes a statement that one or more exchange rates are not to the user's benefit pursuant to the client policy profile.

### BRIEF DESCRIPTION OF THE DRAWINGS

The foregoing features of embodiments will be more readily understood by reference to the following detailed description, taken with reference to the accompanying drawings, in which:

FIG. 1A schematically illustrates an embodiment of an exchange platform in the context of a currency exchange transaction;

FIG. 1B schematically illustrates an embodiment of an exchange platform in the context of a business transaction;

FIG. 1C schematically illustrates an embodiment of an exchange platform in the context of a business transaction;

FIG. 1D schematically illustrates an embodiment of an exchange platform;

FIG. 1E schematically illustrates an embodiment of an exchange platform in the context of a currency exchange transaction;

FIG. 2 is a flowchart of an embodiment of a method for a currency exchange transaction;

FIG. 3A; FIG. 3B; FIG. 3C and FIG. 3D illustrate a process of onboarding a client;

FIG. 4A is a flowchart illustrating a method of forming a commission;

FIG. 4B is a dashboard graphical user interface to facilitate provision and receipt of information to contribute to defining a commission;

FIG. 5A is a flowchart illustrating a currency exchange transaction;

FIG. 5B is a flow diagram illustrating a currency exchange transaction;

FIG. 6 is a flowchart illustrating a currency exchange transaction from the point of view of a platform user;

FIG. 7A schematically illustrates an artificial intelligence engine;

FIG. 7B is a flowchart illustrating a method of operation of an artificial intelligence engine;

FIG. 8A schematically illustrates an embodiment of a method of training an artificial intelligence engine;

FIG. 8B schematically illustrates an embodiment of a method of training an artificial intelligence engine.

### DETAILED DESCRIPTION OF SPECIFIC EMBODIMENTS

Various embodiments improve the operation of computer systems deployed to execute currency conversion from a first fiat currency to a second fiat currency.

Conventional currency conversion systems are under the control of, and are operated by, financial institutions or other third parties. Moreover, such operators are, at points in the conversion process and for at least some period of time, in possession and control of the funds to be converted, and the converted funds.

In contrast, illustrative embodiments operate under user control (e.g., under control of the initiator of a currency exchange transaction), rather than ceding control to an intermediary such as a bank. Moreover, in illustrative embodiments, at no point in the execution of a currency exchange transaction is a third party (e.g., a bank) in possession of in initiator's funds.

Illustrative embodiments configure a currency conversion transaction based not only on the amount of currency to be converted, but on a policy profile provided by the initiator of the currency conversion process.

Illustrative embodiments improve over prior technology related to currency conversion and financial risk management.

Generally, illustrative embodiments provide systems and methods for currency conversion and currency exchange that are immutable, controllable by the user, embedded within the transaction (for example, a transaction of shipping products and materials from a buyer to a seller), and that provide multi-factor security, and reduce the cost of currency conversions. As compared to conventional transactions, the systems and methods tend to minimize currency fluctuation risk for financial transactions that occur across national and international boundaries. Additionally, illustrative embodiments utilize smart commissions to make currency conversions faster and in a less expensive manner, while also increasing individual user control of the transactions required to ship products and materials worldwide.

Moreover, some embodiments incorporate artificial intelligence methods and machine learning to improve the timing of currency exchange transactions and related business decisions.

In some embodiments, an artificial intelligence engine produces a quantitative assessment of future transaction parameters (e.g., predicts a future exchange rate), and some embodiment provide a qualitative assessment of a proposed currency exchange transaction (e.g., whether the user should execute a translation immediately, or at a specified later time), so as to help determine whether or not the user should send the commission or delay in sending the commission. In some embodiments, the artificial intelligence engine can act as a transaction manager for the user to reduce or mitigate risk, to increase trust in the secure platform, or both.

Illustrative embodiments provide solutions that provide a secure platform for creating secure commissions between customers and suppliers with a programmable payment method in the fiat currency of choice. The secure platform provides currency conversion for a transaction cost of 1.5% compared to 5-10%, thereby cumulatively saving companies upwards of trillions of dollars. The secure platform also provides for immediate settlement. Reducing the time between invoicing and paying allows for reduced currency fluctuation risk.

The net result of the secure platform is lower currency conversion costs and nearly immediate settlements. This solution will improve operating margins and reduce currency conversion costs across the shipping and logistics industries.

The following example illustrates the crucial role currency conversion plays in the global supply chain:

1. Novelty Inc. in Los Angeles orders 4000 widgets from Widgets LTD in Busan, Korea.

2. Widgets LTD prepares the order and calls Korea Freight Forwarding to manage the ocean shipping.

3. Korea Freight Forwarding dispatches the Busan Trucking Company to pick up the order at the Widgets LTD facility and transport the widget cargo to the Korea Freight Forwarders facility.

4. At the Korea Freight Forwarding facility: The containers are loaded for shipment; Korea Freight Forwarding fills out the customs forms and calls the Port Drayage Division to have the container delivered to the Singapore Ocean Carrier's port terminal in Busan.

5. In preparing to receive the Widgets LTD cargo, Singapore Ocean Carrier converts Singapore dollars (SGN) to U.S. dollars (USD).

6. Singapore Ocean Carrier buys fuel from the Bunker Company in Busan and pays in USD.

7. Singapore Ocean Carrier transports the container to Los Angeles.

8. The Los Angeles terminal operator unloads the containers.

9. The Customs Brokerage clears the containers for release.

10. The Los Angeles Harbor Drayage Company, who has been contracted by the Singapore Ocean Carrier, picks up the containers and delivers them to Novelty Inc. of Los Angeles.

11. Novelty Inc, of Los Angeles is invoiced by Widgets LTD from Busan Korea.

Novelty Stuff pays Widgets LTD in USD.

Widgets LTD converts USD into local currency, the Korean won.

12. Widgets LTD is invoiced by Korea Freight Forwarding and pays in local currency (won).

13. Korea Freight Forwarding receives invoices from: Busan Trucking Company: Freight Forwarding pays in won; Bussan Container Chassis Pool: Freight Forwarding pays in won, the local currency. ACE Container Leasing from Hong Kong: South Korean Freight Forwarding pays in USD.

Relative to conventional methods and systems, illustrative embodiments provide currency conversions that are faster and less expensive, while also increasing individual user control of the transaction, and reducing currency fluctuation risk. Some embodiments leverage artificial intelligence to predict the outcome of a currency conversation transaction, and based on such predictions advise the user as to the timing of initiating the conversation transaction.

Definitions: As used in this description and the accompanying claims, the following terms shall have the meanings indicated, unless the context otherwise requires.

The term “fiat currency” (or “fiat money”) is a currency defined a legal tender by a government. Fiat currency is not supported by any physical commodity, but is instead supported by the faith of its holders by virtue of a government declaration.

A “commission” is an arrangement between a first party (e.g., an initiator) and a second party (e.g., a recipient) for the transfer of funds from the first party to the second party, which transfer includes an exchange of funds denominated in a first currency (e.g., a first fiat currency) to corresponding funds denominated in a second currency (e.g., a second fiat currency). Execution of the commission may employ services of a cryptocurrency exchange, but in illustrative embodiments the cryptocurrency exchange is not a party to the commission (although, in some embodiments the cryptocurrency exchange may act as an agent to a party to the commission, but even then the cryptocurrency exchange is a third party to the commission). A commission may be memorialized in a document, such as an electronic document, and may be encoded using blockchain technology.

A “set” includes at least one member.

The term “financial risk management” means the process of identifying, evaluating, forecasting and prioritizing risks, such as cyber security, market trends, and trading behavior of the market in specific global exchanges of point specific trading activities segregated by global time zones. This risk management process will enable embodiments of a platform to monitor risk activity and, based on that monitoring, tend to minimize the probability that execution of a currency exchange transaction will suffer negative events such as trading activity that could slow the execution process or the probability of loss due to market price decline or currency fluctuation volatility, tend to maximize the optimal time to realize opportunities, such as a stable trading environment.

The term “overall financial risk management” means to lower the probability that the execution of the payment component of their Smart commission will be secure, will settle in a timely manner and not be negatively impacted by either or Currency exchange fluctuation or Crypto Currency trading fluctuation.

The term “mitigate risk for the user” means to mitigate client risk to unnecessary transaction costs and/or transaction related security risk exposure. In other words, the term “mitigate risk for the user” means to lower the probability that the execution of the payment component of their commission will fail to settle in a timely manner and/or will be negatively impacted by either or currency exchange fluctuation or cryptocurrency trading fluctuation.

The term “optimize crypto and fiat currency conversion value” means to maximize the best possible acquisition cost of crypto and purchase price of fiat currency.

The term “optimize crypto and fiat currency conversion efficiency” means to maximize the time taken to process crypto to fiat currency conversion time.

The term “industry analytics including global supply chain trends” means to gather, analyze and constantly monitor trend data for intelligence that informs conclusions and recommendations.

The term “conditions that the client is willing to accept” means conditions specified by a user (e.g., an initiator) by which a transaction or proposed transaction may be assessed. Such conditions preferably provide transaction environment transparency to user, including time to process, cost(s) to transact.

The term “goals for which the client prefers be accomplished” means those activities that are specified in the commission including the flexibility to execute a payment trade within in a specified time period, exchange a specific currency for another to execute payment, execute an agreed upon transaction.

The term “market trends” means global information and data related to Supply Chain, Global Currency and Global Cryptocurrency fluctuations.

The term “currency market predictions” means predictions of Global fiat currency trends related to direct exchange conversions based historical data.

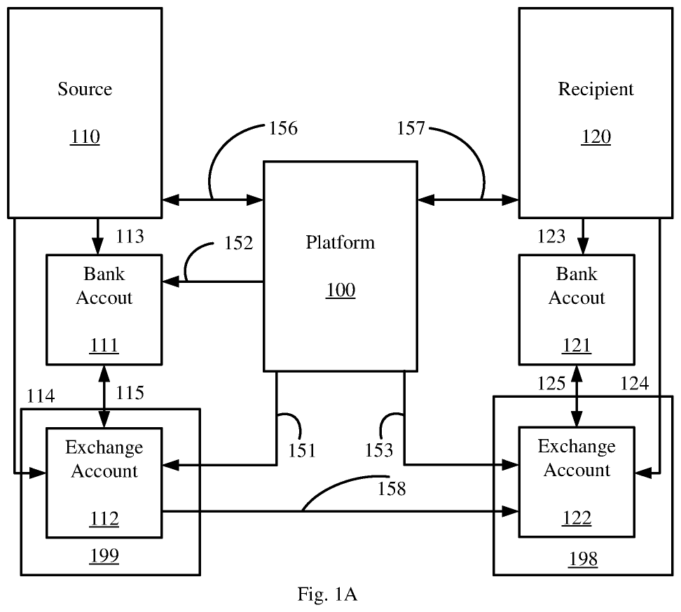

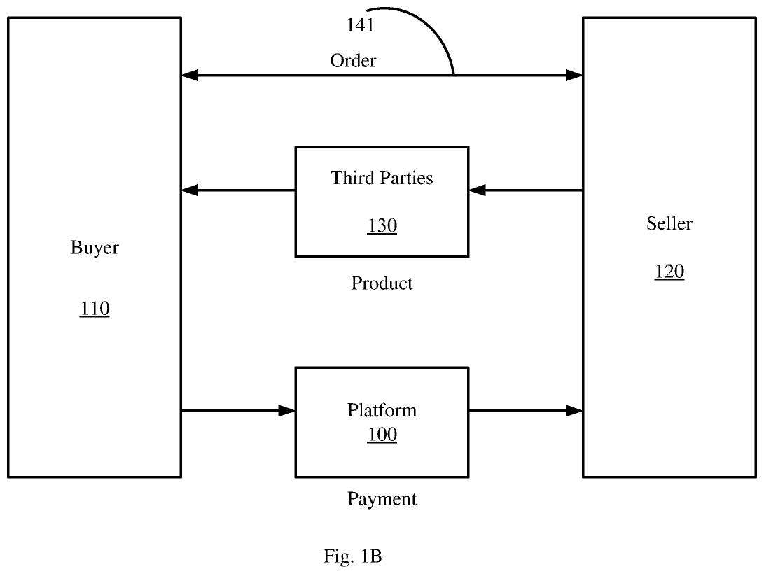

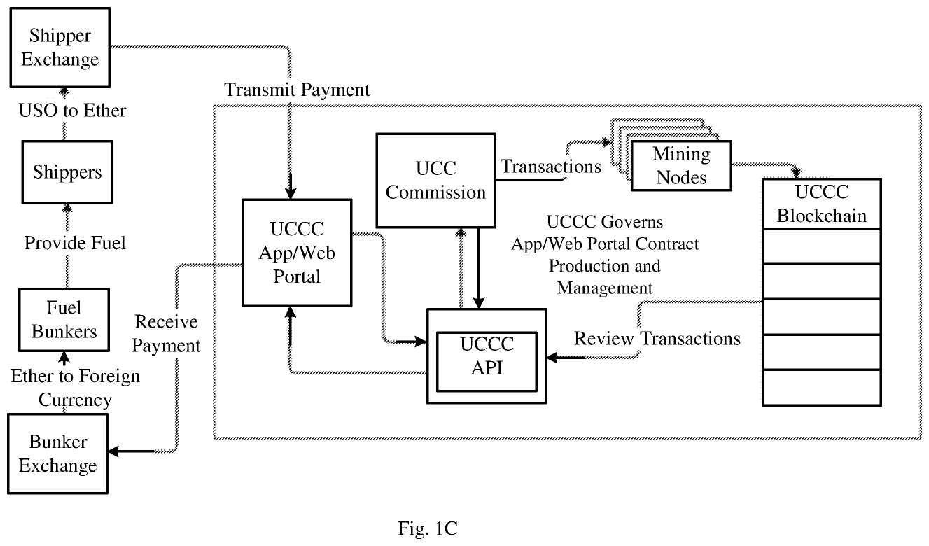

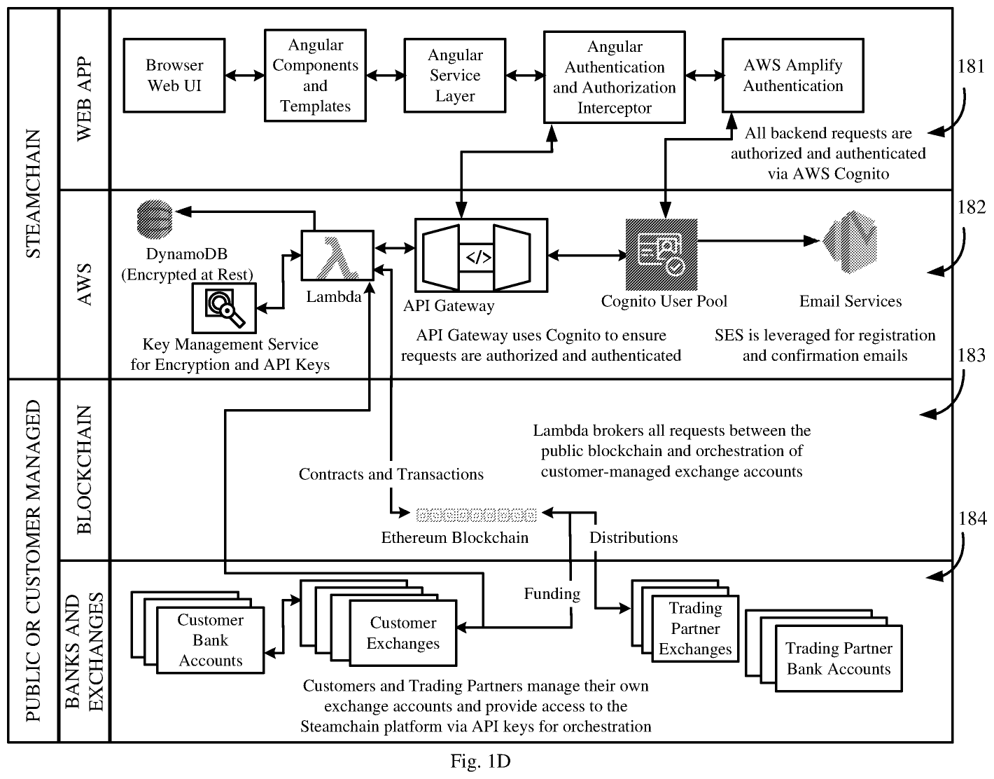

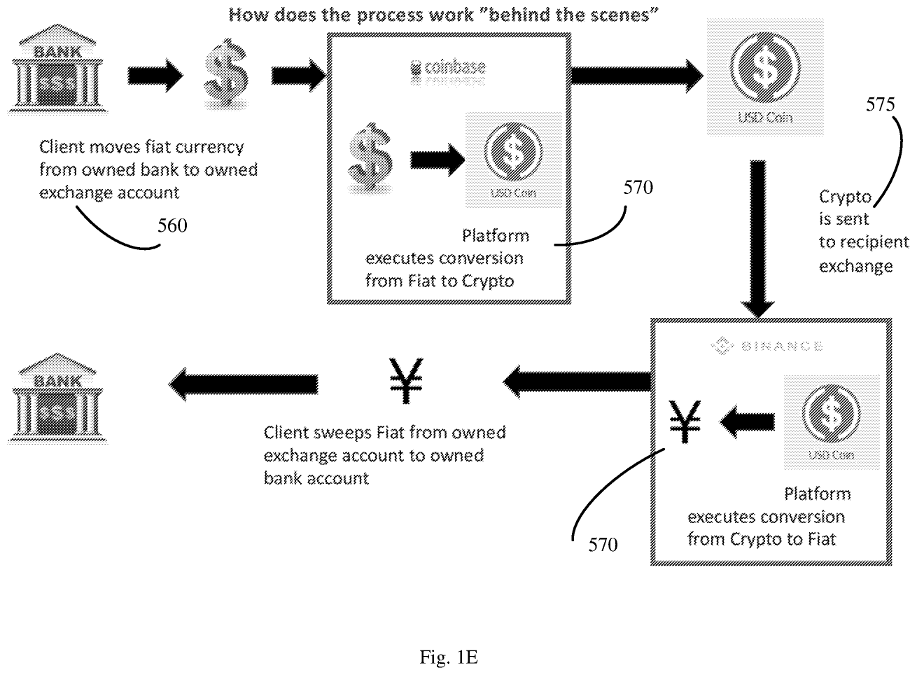

FIG. 1A schematically illustrates an embodiment of a secure platform 100 for currency exchange. The platform 100 may be implemented, in whole or in part, on a computer, and communications among the platform 100 and others computer may be performed over a communications network, such as a local area network, a wide area network, and/or the Internet. In this embodiment, the platform 100 interfaces between a transaction initiator (or “initiating party”) 110, and a set of recipients (or each a “receiving party”) 120. The funder (source, e.g., initiator) 110 and receipts 120, and cryptocurrency exchanges may be implemented, in whole or in part, on a computer, and communications among the platform 100, the source 110, recipients 120 and cryptocurrency exchanges 198, 199, and banks may be performed over a communications network, such as a local area network, a wide area network, and/or the Internet.

In some embodiments, the initiator 110 and the recipient 120 are different parties, for example different persons or entities, and in other embodiments the initiator 110 and the recipient 120 are the same party. In some embodiments, the set of recipients 120 are a single recipient, and in some embodiments the set of recipients includes a plurality of recipients (or a plurality of “receiving parties”). It should be noted that various embodiments may involve different numbers of parties to a commission. For example: a) Two entities (one initiator 110 and a single recipient 120), which is a “B2B” transaction model; b) Single entity (the initiator 110 and recipient 120 are the same party) —one client utilizing our platform for themselves only, e.g., to exchange client funds denominated in a first fiat currency to client funds denominated in a second, different, fiat currency); and c) Multiple Entities (one initiator 110 and a plurality of recipients 120) —a “B2 many” model. One originator and multiple recipients (e.g. One originating Fiat currency and One destination Fiat currency). Also not included in the supplied documents. In some embodiments, the initiator is the source of funds that fund the transaction. In other embodiments, the initiator is a recipient 120.

In some of the following embodiments, the initiator is the source 110 of funds that fund the transaction, and will be referred-to as “initiator 110.”

The initiator 110 has a bank account 111, and an exchange account 112. The initiator 110 is in communication 113 with its bank account 111 and is in communication 114 with its exchange account 112, and can move funds 115 from its bank account 111 to its exchange account 112, and from its exchange account 112 to its bank account 111.

The recipient also has an exchange account 122, and preferably also has a bank account 121. The recipient 120 is in communication 123 with its bank account 121 and is in communication 124 with the exchange account 122, and can move funds 125 from its bank account 121 to its exchange account 122, and from its exchange account 122 to its bank account 121.

In operation, the imitator 110 has funds denominated in a first fiat currency in its bank account 111 or its exchange account 112. The initiator 110 desires to send funds to the recipient 120, but the recipient 120 requires funds denominated in a second fiat currency.

To that end, in illustrative embodiments, the platform 100 provides a service to the initiator 110, and for the benefit of the recipient 120. The initiator 110 is in communication 156 with the platform 100, and the initiator 110 provides to the platform 100, and the platform 100 receives from the initiator, a commission. The commission includes details for the execution of a transaction by which the platform executes a currency exchange transaction on behalf of the initiator. In illustrative embodiments, the platform 100 acts as an agent of the initiator 110, and the authority of the platform 100 in its capacity as agent is defined by, and limited by, the authority granted to the platform 100 by the initiator 110. Moreover, the ability of the platform 100 to access or control funds belonging to the initiator (“initiator funds”) is limited, pursuant to the scope of that agency, by the bank holding the bank account 111 and the cryptocurrency exchange 199 holding the exchange account 112.

In executing the transaction, the platform 100 directs the cryptocurrency exchange, in a first conversion process, to exchange initiator funds denominated in a first fiat currency in the exchange account 112 into a set of cryptocurrencies (the “crypto funds”), and to hold the crypto funds in the exchange account 112. To that end, the platform 100 is in communication 151 with the initiator's exchange account 112. The set of cryptocurrencies may include a single cryptocurrency (e.g., Bitcoin, Tether, Stellar, USDC, and Ethereum, to name but a few examples), or a plurality of cryptocurrencies. In preferred embodiments, each such cryptocurrency is based on the ERC-20 technology foundation, and/or is broadly leveraged and utilized, and is secure.

In some embodiments, the platform 100 directs the initiator's bank account 111 to transfer funds to the initiator's exchange account 112. To that end, the platform 100 is in communication 152 with the initiator's bank account 111.

Subsequent to the first conversion process, the platform 100 directs the cryptocurrency exchange 199, in a second conversion process, to convert the set of cryptocurrencies to a second fiat currency (“recipient funds”).

Subsequent to the second conversion process, the platform 100 directs the cryptocurrency exchange 199 to transfer the recipient funds to the recipient's exchange account 122 or, in some embodiments, the recipient's bank account 121. In illustrative embodiments, the recipient's exchange account 122 is held by the same cryptocurrency exchange 199 as the initiator's exchange account 112. In other illustrative embodiments, the recipient's exchange account 122 is held by a different cryptocurrency exchange (which may be referred to as cryptocurrency exchange 198) than the cryptocurrency exchange 199 holding the initiator's exchange account 112.

Some embodiment involve communication between the initiator 110 and one or more recipients 120. To that end, some embodiments of the platform 100 include communications facilities to receive communications from the initiator 110 and forward them to the recipient 120, and to receive communications from the recipient 120 and forward them to the initiator 110. To that end, the platform 100 is in communication 156 with the initiator 110 and is in communication 157 with the recipient 120.

FIG. 1B schematically illustrates an example of the operation of a secure platform within the context of a purchase and sales transaction, according to an illustrative embodiment in which the initiator 110 is a buyer of goods and/or services from a seller, wherein the seller is a member of the set of recipients 120. In this embodiment, the buyer 110 sends and order 141 to the seller 120 for goods and/or services, and the seller accepts the order and forms a commercial contract. The buyer (as initiator 110) sends payment to the seller (as recipient) using the platform 100, and the seller sends the goods and/or services to the buyer, often through, or in conjunction with, a set of one or more third parties 130. In some embodiments, the seller 120 pays some or all of the third parties 130 such as from funds in the second fiat currency received from the buyer 110 by use of the platform 100, and in some embodiments, the buyer 110 pays some of or all of the third parties by use of the platform 100.

FIG. 1C schematically illustrates an example of the operation of a secure platform 100 within the context of a portion of a purchase and sales transaction, according to an illustrative embodiment in which the initiator 110 is a buyer of goods and/or services from a seller, wherein the seller is a member of the set of recipients 120. FIG. 1C is a schematic representation of the general process flow for exchanging fiat for fuel commodities. This diagram is not a complete or in-depth diagram of all components within the system.

The architecture is configured to enable the secure platform to integrate multiple stable coins (e.g., Tether, Stellar, USDC, and Ethereum) and other cryptocurrencies based on the ERC-20 technology foundation that are broadly leveraged and utilized, and are secure.

“UCCC App/Web Portal” of FIG. 1C includes the components, functionality, or both of the “Steamchain Corp. Web App” row (first row 181) of FIG. 1D, discussed below.

“UCC API” of FIG. 1C includes the components, functionality, or both of the “Steamchain Corp. AWS” and the “Blockchain” rows (second row 182 and third row 183, respectively) of FIG. 1D, discussed below.

“UCC Blockchain” and “Mining Nodes” of FIG. 1C include the components, functionality, or both of the “Blockchain” row (third row 183) of FIG. 1D, discussed below.

“UCC Smart commissions” of FIG. 1C includes the components, functionality, or both of the “Blockchain” and “Banks and Exchanges” of FIG. 1D (third row 183 and fourth row 184, respectively).

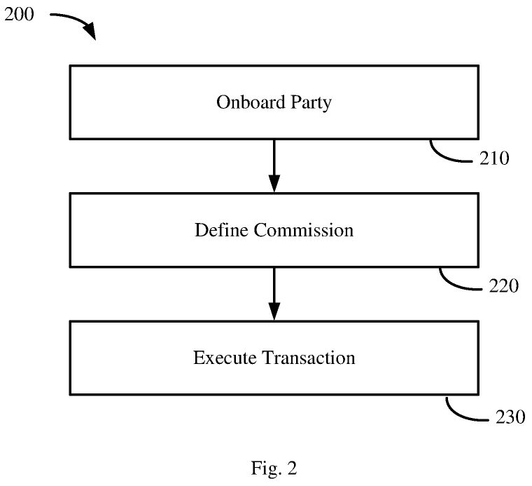

FIG. 2A is a flow chart illustrating an embodiment of a method 200 of employing an embodiment of a secure platform.

Step 210 includes onboarding a party to the transaction, such as the initiator 110 for example.

Step 220 includes defining (e.g., forming) a commission. In illustrative embodiments, the commission is defined by the platform 100 based on input parameters from the initiator 110.

Step 230 includes execution a transaction defined by the commission.

Additional detail is regarding illustrative embodiments is provided below.

Onboarding

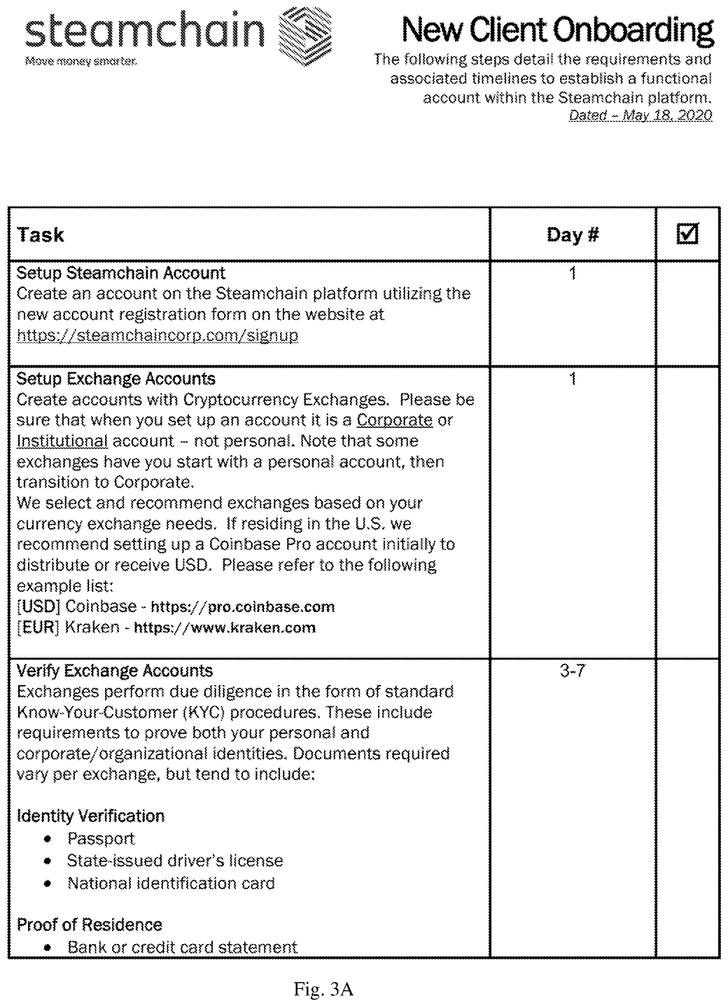

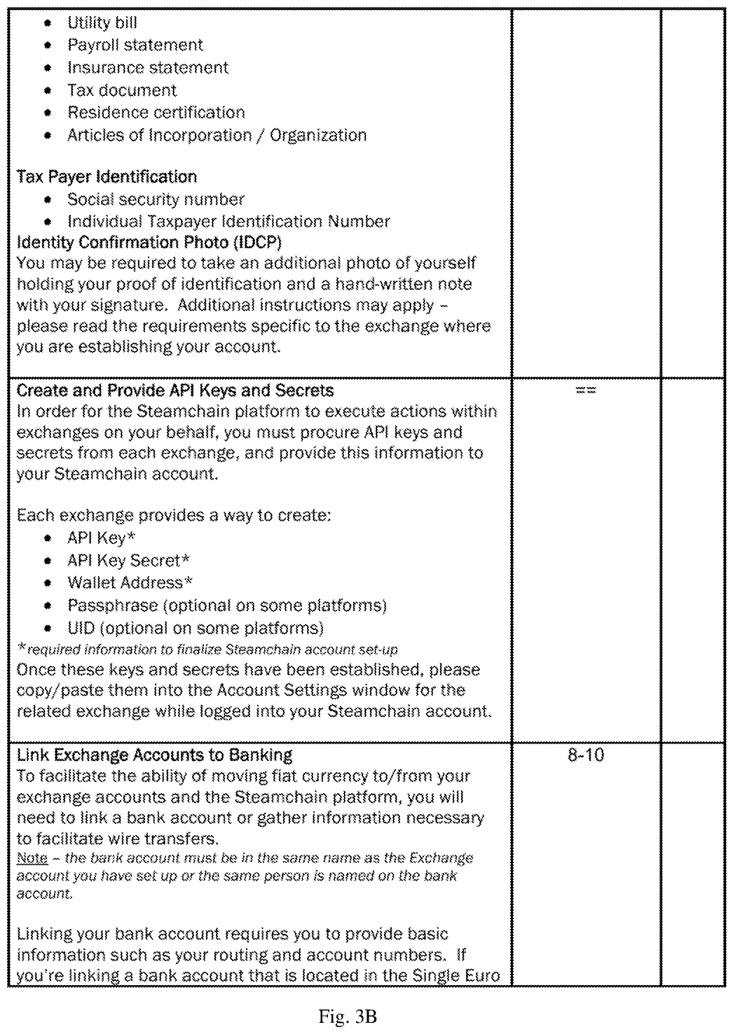

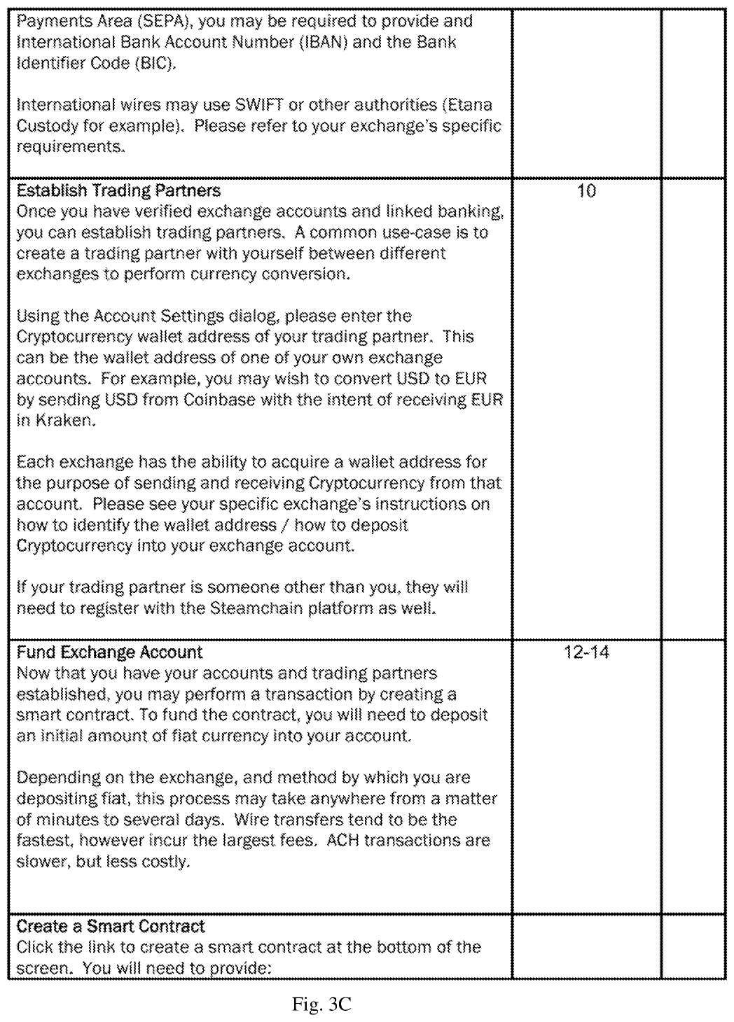

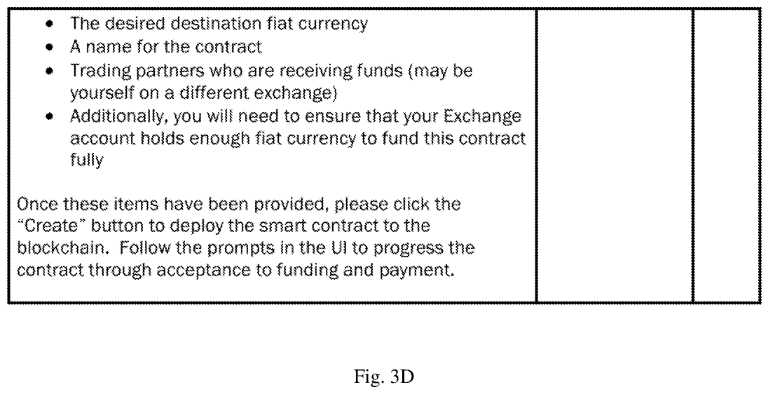

FIG. 3A; FIG. 3B, FIG. 3C and FIG. 3D are, collectively, a flow chart illustrating an embodiment of a method of onboarding a client.

During new client onboarding, the platform 100 helps the new client setup an exchange account, if the client does not already have one setup. In some embodiments, the platform 100 recommends one or more exchanges based on various criteria associated with the new client. For example, the platform 100 may recommend that US-based clients initially set up a Coinbase Pro account. As another example, the platform 100 may recommend an exchange based on the starting currency and ending currency, as certain fiat currencies are not supported by certain exchanges.

A Commission for Transaction

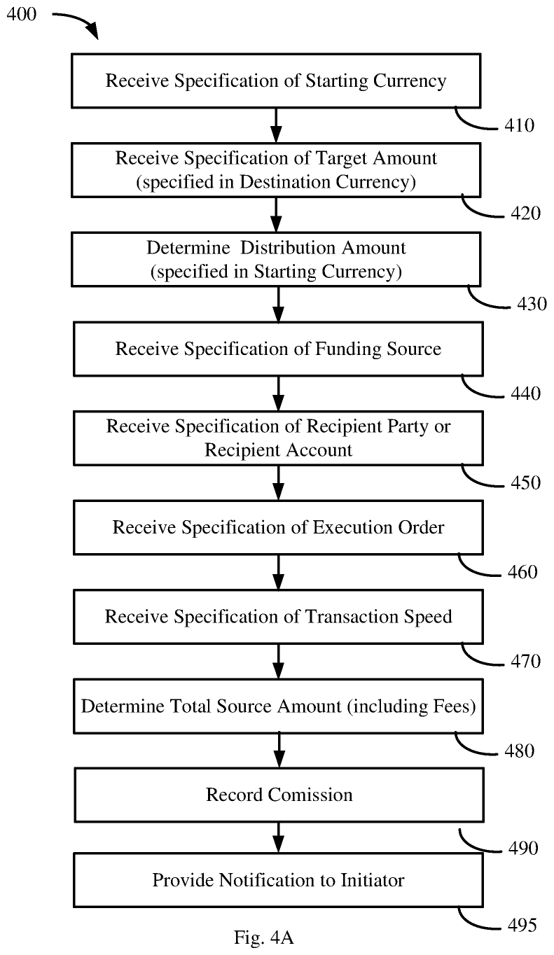

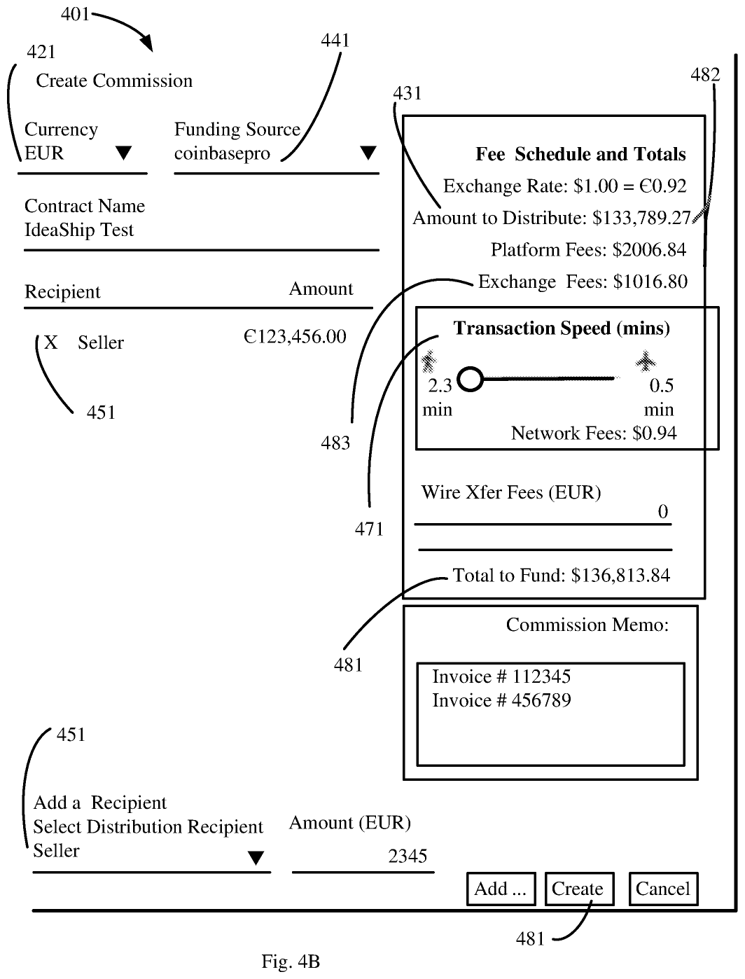

FIG. 4A is a flow chart illustrating an embodiment of a method 400 of defining a commission. FIG. 4B schematically illustrates a graphical user interface (or “GUI”) 401 configured to allow an initiator to enter, and provide to a platform 100, at least information defining a transaction.

The method 400 begins with receiving, or acquiring, specification of certain information. See, for example, the information acquired in the GUI 401 of FIG. 4B, which includes some of that information.

In illustrative embodiments, the method receives the specification of the information from the initiator 110, for example via a graphical user interface 401, such as the graphical user interface schematically illustrated in FIG. 4B, although some embodiments may receive specification of some information from a recipient 120.

Beginning with FIG. 4A, at step 410, the method includes acquiring or receiving, by the platform 100, specification of the starting currency 411. In illustrative embodiments, the platform 100 receives the specification of the starting currency from the initiator 110. As noted above, in some embodiments the initiator is the source 110, and in some embodiment the initiator is a recipient 120.

At step 420, the method includes acquiring or receiving, by the platform 100, specification 421 of the destination currency. In illustrative embodiments, the platform 100 receives the specification of the destination currency from the initiator 110.

At step 430, the method includes determining the distribution amount 431, for example denominated in the starting currency. In illustrative embodiments, the distribution amount is the amount (i.e., the net sum) owed by the initiator 110 to the recipient 120.

At step 440, the method includes acquiring or receiving, by the platform 100, specification 441 of a funding source. In illustrative embodiments, the platform 100 receives the specification 441 of the funding source from the initiator 110. In some embodiments, the funding source is the initiator's exchange account 112.

At step 450, the method includes acquiring or receiving, by the platform 100, specification 451 of the recipient party 120, and/or specification of a recipient exchange account 122 or bank account 121. In illustrative embodiments, the platform 100 receives the specification of recipient party 120, and/or recipient exchange account 122 or bank account 121 from the initiator 110. In other embodiments, the platform 100 receives the specification of the recipient party 120, and/or recipient exchange account 122 or bank account 121 from the recipient 120.

Some embodiments include, at step 460 in cases where the commission specifies a plurality of transactions, acquiring or receiving, by the platform 100, specification of a transaction order. The transaction order specifies a preferred or required order of the plurality of transactions.

Some embodiments include, at step 470, acquiring or receiving, by the platform 100, specification 471 of a transaction speed. A transaction speed specified a time frame by which the transaction must be completed. In illustrative embodiments, the time frame may be specified in seconds, minutes, days, or other time frame desired by the part specifying the speed. In illustrative embodiments, the platform 100 receives the specification of the transaction speed from the initiator 110.

Some embodiments include, at step 480, determining the total amount of funds from the specified source. For example, the method 400 may determine an amount of funds 481 from the specified source equal to the sum of the amount to be delivered to the recipient 120 (i.e., the net sum; 431), plus any fees or other distributions. Such fees may include, for example, fees charged by the platform 100 (“platform fees”) 481, and/or fees charged by the cryptocurrency exchange (“exchange fees”) 483.

The user may, at step 490, create a commission document (which may be referred-to simply as a “commission”) which document records the information acquired in process 400. For example, the user may create the commission by clicking the “Create” button 491.

At step 495, the method includes providing, by the platform 100, notification to the initiator 110. For example, in some embodiments the notification may include notifying the initiator 110 of the content of the commission. Alternatively, or in addition, in some embodiments the notification includes notifying the initiator of a qualitative and/or qualitative assessment of a proposed transaction. Such a notification may be generated, for example, by an artificial intelligence 700 as described herein. In some embodiments, the notification is generated by an artificial intelligence based on at least one of market conditions, or conditions of the commission; and the assessment includes a qualitative assessment of the outcome of the currency transaction if the currency transaction were to be executed at the time indicated by the notification. In some embodiments, the notification is generated by an artificial intelligence based on at least one of market conditions, or conditions of the commission; and the assessment includes a recommendation of a point in time at which the currency transaction would be more beneficial for the initiator.

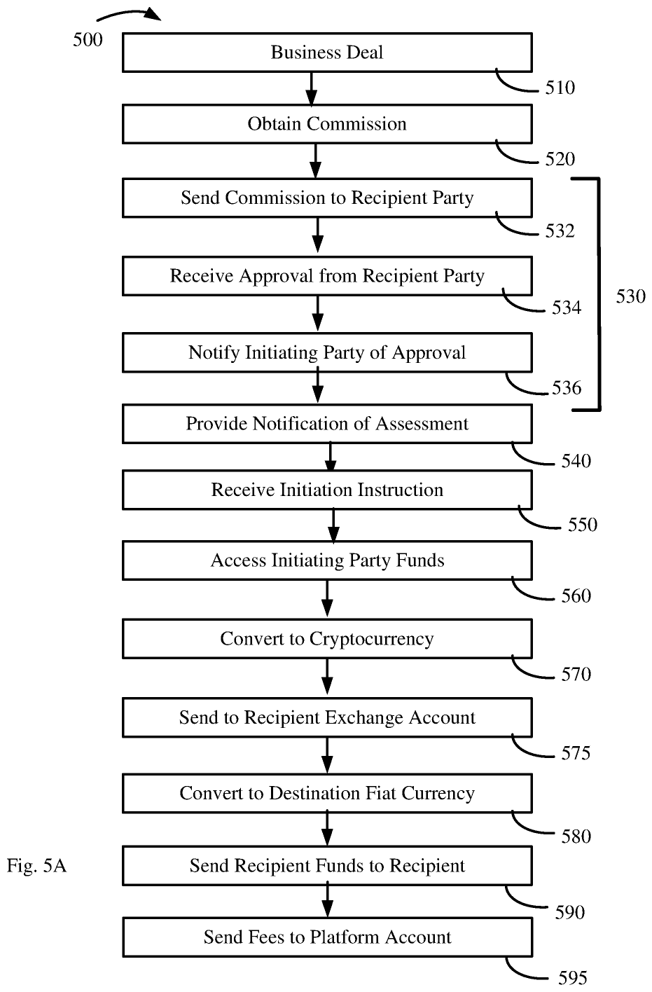

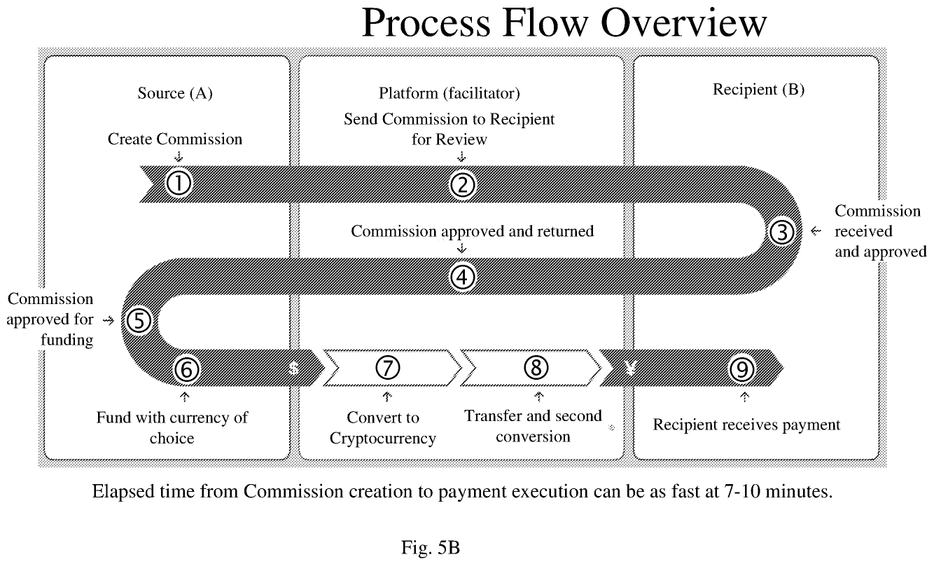

FIG. 5A is a flow chart illustrating an embodiment of a method 500 of performing a currency exchange transaction with a secure platform.

Some embodiments begin, at step 510, by including formation of a business transaction, which business transaction includes transfer of funds from one party to at least one other party. Rather than moving and exchanging funds through conventional channels (e.g., a bank), such transfer of funds may be facilitated by a platform 100 as described herein.

Step 520 includes obtaining a commission. Step 520 may be provided through the process 400 described above, for example. In some embodiments, the commission is encoded by blockchain technology. In some embodiments, step 520 also includes obtaining approval of the commission from the initiator 110.

In some embodiments, the obtaining the commission includes obtaining one or more of: an amount of risk the client is willing to accept in the currency exchange transaction; a type of financial return desired by the client in the currency exchange transaction; an amount of financial return desired by the client in the currency exchange transaction; a cost of the currency exchange transaction acceptable to the client; a completion deadline for the currency exchange transaction; and/or a transaction duration, for the currency exchange transaction, acceptable to the client.

Some embodiments include acquiring, by the initiator 110, approval of the commission by the recipient party 120. The acquisition of such approval may be performed via process 530, including steps 532-536. At step 532, the process sends the commission to the recipient party 120. The commission may be sent by the initiator 110 via any convention channel (e.g., email), or may be sent through the platform 100. Preferably, the commission is encoded using blockchain technology. Step 534 includes receiving, from the recipient party 120, approval of the commission. Preferably, the approval is encoded using blockchain technology. It should be noted that if the recipient party 120 does not approve of the commission, then the recipient party 120 and the initiating party 110 may engage in dialog and negotiation to revise the commission until the recipient party provides, and the initiating party 110 receives, the recipient party's approval of the commission at step 534. At step 536, the process includes notifying (e.g., by the platform 100), the initiator party 110 that the recipient 120 has approved of the commission. Preferably, the approval notification is encoded using blockchain technology. In some embodiments, the all communications of process 530 are encoded using blockchain technology.

Some embodiments include step 540, in which the platform 100 provides, to the initiator 110, a notification including a qualitative and/or quantitative assessment of the (not yet executed) transaction defined by the commission but not yet executed (the “proposed transaction”). In illustrative embodiments, the assessment is produced by an artificial intelligence engine 700, as described below.

Step 550 includes receiving, from the initiator 110, instructions to execute the proposed transaction. Such instructions may be received, for example, in response to a study and consideration by the initiator 110 of a notification from the platform 100 including an assessment of the proposed transaction. Such instructions may include an instruction to execute the proposed transaction immediately, an instruction to execute the proposed transaction at a defined future time or after a defined delay.

At step 560, the platform 100 obtains access to funds of the initiator 110, which funds are preferably sufficient to fund the transaction defined by the commission. In some embodiments, the communications of step 560 are encoded using blockchain technology. In some embodiments, step 560 occurs prior to receipt, by the platform 100, of the initiation instructions of step 550.

In some embodiments, the initiator 110 also grants, to the platform 100, a limited authority 152 to control the bank account 111 of the initiator 110. That limited authority is defined as the authority for, and only for, the platform 100 to cause transfer of funds from the bank account 111 of the initiator 110 to the exchange account 112 of the initiator 110 (see, for example, FIG. 1E). Such limited authority, which may be defined as “limited bank account authority,” does not allow to the platform any other authority more than required to perform the specified transfer. For example, the limited bank account authority does not include authority to transfer funds from the initiator's bank account 111 to any other bank account or any other exchange account. Consequently, funds in the initiator's bank account 111 remains under the control of the initiator 110.

At step 570, the platform 100 causes the exchange account 112 of the initiator 110 to exchange initiator funds first to a set of cryptocurrencies (an “origin exchange”). Some embodiments include, at step 575, sending the set of cryptocurrencies to an exchange account 122 held by the recipient 120, and other embodiments hold the set of cryptocurrencies in the initiator's exchange account 112 until after the recipient exchange described below.

At step 580, the platform 100 causes exchange of those cryptocurrencies to a second fiat currency (a “recipient exchange”). The platform 100 causes the recipient exchange via whichever exchange account is holding the funds—the initiator's exchange account 112 or the recipient's exchange account 122. In embodiments in which the cryptocurrencies are held in the recipient's exchange account 122, the platform 100 is in communication 153 with the recipient's exchange account 122, and has limited authority to cause the recipient's exchange account 122 to execute the recipient exchange. Such limited authority, which may be defined as “limited recipient exchange account authority,” preferably does not include authority greater than necessary to perform the specified currency exchanges. For example, in illustrative embodiments, the authority does not allow to the platform 100 authority to transfer funds from the recipient's exchange account 122 to any other bank account or any other exchange account. Consequently, funds in the recipient's exchange account 122 remain under the control of the recipient 120.

In some embodiments, the platform 100 recommends the set of cryptocurrencies, for example based on a combination of the first fiat currency (e.g., the “source” fiat currency”) and the second fiat currency (e.g., the “destination” fiat currency) prior to executing the currency conversion transaction. In some embodiments, one or both of origin exchange of step 570, and the recipient exchange of step 580, is encoded using blockchain technology.

To that end, in illustrative embodiments, the initiator 110 provides, to the platform 100, a limited authority 151 to cause the exchange account 112 of the initiator 110 to execute currency exchanges using initiator funds in the exchange account 112. That limited authority is defined as the authority for, and only for, the platform 100 to cause exchange (e.g., at a first time) of initiator funds denominated in a first fiat currency to funds denominated in a set of one (or more) cryptocurrencies (“crypto funds”), and for the platform 100 to cause exchange (e.g., at a second time subsequent to the first time) of the crypto funds to funds (“recipient funds”) denominated in a second fiat currency. Such limited authority, which may be defined as “limited funder exchange account authority,” preferably does not include authority greater than necessary to perform the specified currency exchanges. For example, in illustrative embodiments, the authority does not allow to the platform 100 authority to transfer funds from the initiator's exchange account 112 to any other bank account or any other exchange account. Consequently, funds in the initiator's exchange account 112 remains under the control of the initiator 110.

At step 590, the method includes sending the recipient funds to the recipient 120, if that has not already been done. In illustrative embodiments, the method causes the transfer of recipient funds to the recipient's exchange account 122, or to the recipient's bank account 121, to name but two examples. In some embodiments, recipient funds settle within the recipient's exchange account 122. In general, each recipient 120 has the ability to sweep the recipient funds to its own bank account 121, leave the recipient funds at the destination exchange account 122 as Fiat currency, or send the recipient funds to another destination of its choosing.

Some embodiments include step 595, in which the platform 100 sends platform fees, which have been earned by the platform 100 for executing the transaction, to an account held by the proprietor of the platform.

In illustrative embodiments, the funds do not pass into or through any account not controlled by one of the initiator 110 or the recipient 120. For example, in illustrative embodiments, the funds do not pass through the platform 100, or any account controlled by the platform 100.

In some embodiments, the recipient 120 may include a plurality of recipients. In other words, some embodiments implement a transaction model that includes an initiator 110 (or “originating Client”) and multiple recipients 120 (or “recipient Clients”). In such embodiments, the initiator 110 provides converted funds to a first recipient 120 (e.g., Client B) and also, in the same transaction, to a second recipient (e.g., Client C). Moreover, in some such embodiments, the platform provides, and each of the first recipient 120 and the second recipient 120 receives, respectively, funds in a corresponding second fiat currency.

In some such embodiments, process 530 includes seeking and receiving approval of a commission by one or more of the recipients 120. In some such embodiments, step 580 includes converting crypto funds to a set of one or more second fiat currencies. For example, if a first one of the plurality of recipients 120 requires funds denominated in a specified second fiat currency (“primary specified fiat currency”), and second one of the plurality of recipients 120 requires funds denominated in a different specified second fiat currency (“secondary specified fiat currency”), then step 580 includes converting a portion of the crypto funds to funds (“first recipient funds”) denominated in the primary specified fiat currency and converting another portion of the crypto funds to funds (“second recipient funds”) denominated in the secondary specified fiat currency. In some such embodiments, step 590 includes sending the first recipient funds to the first recipient 120 sending the second recipient funds to the second recipient 120.

FIG. 5B schematically illustrates a currency transaction flow among two parties facilitated by a secure platform.

At 1, Company A (the initiator 110) creates a commission on the secure platform 100. To create the commission, Company A first logs into the secure platform 100, such as via website or mobile application. Company A can create the commission with the dashboard provided on the secure platform (see FIG. 4B).

To form the commission, Company A selects the currency to which conversion will occur. Company A also adds the amount of currency to which conversion will occur. The secure platform calculates a distribution amount in a starting currency (i.e., currency from which conversion occurs) required to be converted to the destination currency (i.e., currency to which conversion occurs). This calculation can be determined by the currency exchange rates at the time of commission initiation. The secure platform can provide, display, or calculate up-to-the-minute currency exchange rates for Company A.

Company A also selects a funding source. The funding source is one of the crypto exchanges for which Company A has an account. The secure platform 100 can recommend a crypto exchange to Company A based on the starting currency and information about Company B, including the location and the ending currency.

Company A also provides or selects the recipient 120, which is Company B in this instance. Company B can be selected from a dropdown menu or Company B's wallet address can be input into a recipient box.

A commission can include a single transaction or can include multiple transactions bundled together. When multiple transactions are bundled together, each transaction is added individually to the commission. The multiple transactions can be processed concurrently (i.e., processed separately but at the same time) or can be processed together (i.e., sum of currency to be converted is processed at one time) by the secure platform. In one example, each transaction is added to the blockchain as individual blocks. In another example, the transactions are added to the same block of the blockchain.

The secure platform also calculates a total fee or amount owed by Company A. The total fee or amount includes the distribution amount, a platform fee, an exchange fee, and a network fee. The secure platform fee, which can be a flat fee or a percentage of the distributed amount, is a fee charged by the secure platform to initiate and perform the commission. The exchange fee is a fee for the actual sale of the starting currency, the buy of the cryptocurrency, the sell of the cryptocurrency, and the buy of the destination currency. The network fee is the cost to confirm the transaction on the blockchain and relates to the speed of the transaction. The network fee is proportional to the speed of the transaction (i.e., faster is more expensive, slower is less expensive).

The transaction speed can be changed by sliding the cursor displayed on the dashboard (i.e., “human” side of the slide bar is slowest and “airplane” side of the slide bar is the fastest), FIG. 4B. The network fee is adjusted to account for a change in the transaction speed—the network fee is proportional to the transaction speed (i.e., faster is more expensive, slower is less expensive). Thus, Company A can easily adjust the relationship between the transaction speed and network fee, such as by sliding the cursor.

Before completing the commission, the secure platform can also generate a notification to Company A to send the commission or delay in sending the commission. The notification can be an instruction or alert generated or output by artificial intelligence based on one or more inputs or conditions of the commission. The artificial intelligence is further discussed below.

For example, if the commission is to be executed to convert $X USD into 100 Euros, Company A selects Euros for the currency to which conversion eventually occurs and writes or selects “100 Euro” into or from a graphical user interface 401.

At 2, the platform 100 sends the commission to Company B 120. Company B 120 can be on the secure platform or does not have to be on the secure platform. In illustrative embodiments, Company B 120 does need an exchange account in order to receive the funds via the commission process. Company B's exchange account wallet information can be added to the secure platform and is encrypted.

At 3, Company B 120 reviews and approves or rejects the commission. A rejected commission can be returned to Company A 110 for revisions. The rejected commission can be returned with comments or notes.

When approved, at 4, the platform 100 returns the commission to Company A 110.

At 5, the commission is approved for funding.

At 6, Company A 110 funds the commission with a currency of choice. Company A 110 gives permission to the secure platform 100 to access Company A's exchange account 112 to pull the distributed amount and convert it into a cryptocurrency.

The secure platform 100 does not have possession of the exchange funds, but is given permission access the funds for a transaction. The secure platform 100 has a direct link 151 to Company A's exchange account 112, which also provides the currency held by Company A 110 and the total amount in the exchange account. This permits Company A 110 and the secure platform 100 to determine whether or not Company A 110 has enough funds by which to create a commission. The secure platform can also connect 152 to Company A's bank 111 if the exchange account is underfunded to withdraw an amount needed to fully fund the commission.

At 7, the secure platform 100 can then execute the commission on behalf of Company A, such that the distributed amount in a first currency is used to purchase cryptocurrency on the exchange.

The commission is at fluctuation risk between steps 7 and 8. The time from 7 to 8 is approximately 90 seconds (and being further reduced with continuous technology enhancements). The currency exposure can be further reduced by leveraging USDC, which is a stable coin. It is mapped one-to-one to the USD, thereby eliminating any fluctuation to reduce or eliminate risk for the user.

At 8, the cryptocurrency is transferred to Company B's account and the cryptocurrency is sold with the resulting funds provided in a second currency.

At 9, Company B receives payment in the second currency.

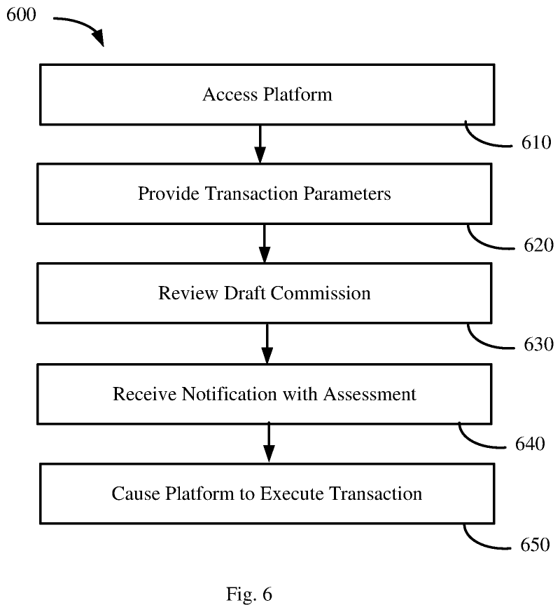

FIG. 6 is a flow chart illustrating an embodiment of a method 600 for controlling a currency exchange transaction from the perspective of user (e.g., an initiator 110).

Step 610 includes accessing a secure exchange platform 100.

Step 620 includes providing, to the secure exchange platform 100, parameters of a proposed currency exchange transaction. The parameters are sufficient to define a commission, as described above. The commission defines an agreed currency exchange transaction between an initiator and a recipient, the agreed currency exchange transaction including (i) accessing, by the secure exchange platform 100, funds of initiator defined in a first fiat currency (“initiator funds”); (ii) causing exchange of the initiator funds into a cryptocurrency (“crypto funds”) by a first crypto exchange process; (iii) subsequently causing exchange of the crypto funds by a second crypto exchange process into funds denominated in a second fiat currency (“recipient funds”), the second fiat currency being different than the first fiat currency; and (iv) securing the recipient funds in an account.

Step 630 includes reviewing a commission produced by the secure exchange platform 100. In some embodiments, reviewing such commission includes a process 430 as disclosed above.

Some embodiments include step 640, which includes receiving from the platform a notification including an assessment of a proposed transaction. Such an assessment may be produced by an artificial intelligence engine, as described herein.

Step 650 includes causing the secure exchange platform 100 to execute the agreed currency exchange transaction. Causing the secure exchange platform 100 to execute the agreed currency exchange transaction may include initiating execution of the agreed currency exchange transaction, such as by instructing the secure exchange platform 100 to execute the agreed currency exchange transaction, or instructing the secure exchange platform to execute the agreed currency exchange transaction at a specified future time.

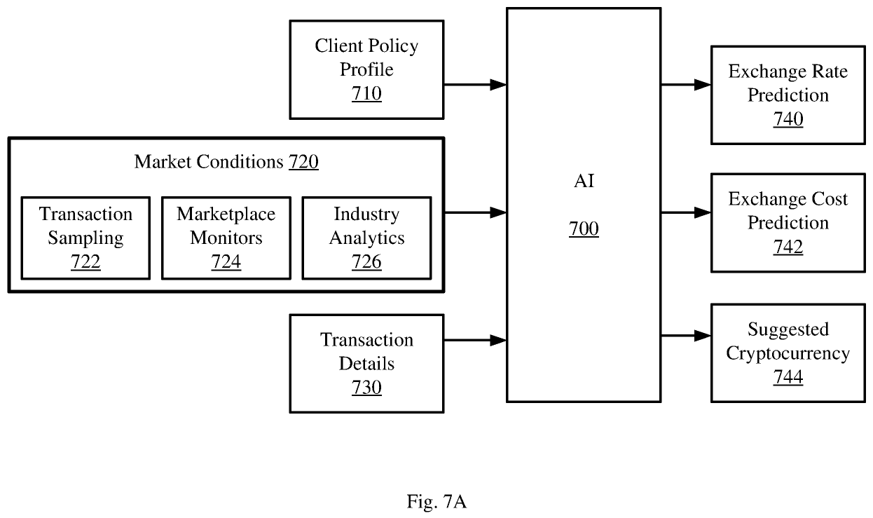

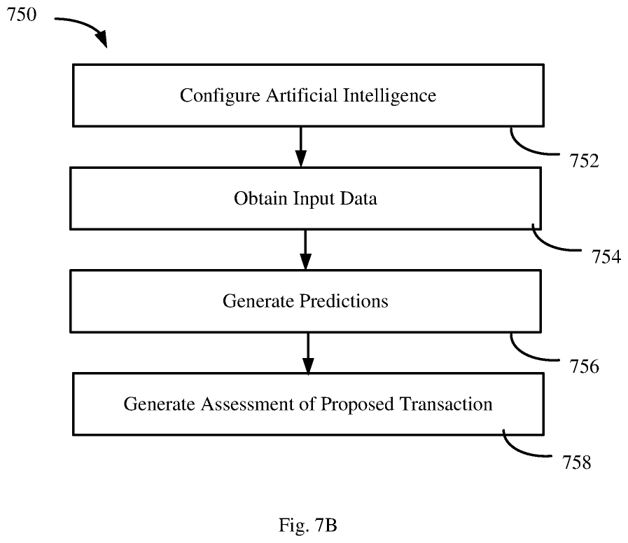

FIG. 7A schematically illustrates an artificial intelligence engine 700. Some illustrative embodiments of a platform 100 incorporate such an artificial intelligence engine 700 that employs artificial intelligence methods and machine learning to assess the timing of currency exchange transactions and related business decisions. Generally, the artificial intelligence engine can generate predictions, as will be further discussed below, based on targeted information and broad information. For example, the artificial intelligence engine produces an assessment of a proposed transaction to assist a user in determining whether or not the user should execute a proposed transaction, or delay. In some embodiments, the artificial intelligence engine suggests a future time to execute the transaction.

To those ends, the artificial intelligence engine 700 (or a platform 100 employing the artificial intelligence engine) produces a notification to a user (e.g., initiator 110). The notification can be an instruction or alert generated or output by the artificial intelligence engine based on one or more inputs or conditions of the commission. The notification, in some embodiments, also includes a point in time in which the benefit to the user is greater than the current benefit. The user can instruct the secure platform to execute the commission at that point in time, at which point the secure platform will execute the commission. In other words, the artificial intelligence engine can act as a transaction manager for the user to reduce or mitigate risk, to increase trust in the secure platform, or both.

For example, the notification can state, “The exchange rate is not to your benefit. Proceed if you would like.” The initiator 110 can decide to proceed with the transaction, or to wait. The notification can also include or indicate a point in time in which the transaction would be more beneficial for the initiator 110.

For the secure platform 100, the artificial intelligence engine 700 is driven in part by a client policy profile 710.

In illustrative embodiments, the artificial intelligence engine 700 is driven in part by market conditions 720, including previous platform transactions, and marketplace monitors. For example, the artificial intelligence engine 700 recognizes currency exchange patterns and triggers a notification to the initiator 110 to reduce or mitigate risk for the initiator 110. The artificial intelligence engine 700 uses pattern-recognition of market trends and transaction conditions to seek to optimize user benefits, such as reduced transaction fees or more favorable currency exchange rates. In other words, the secure platform can incorporate AI-driven, real-time currency market predictions to optimize crypto and fiat currency conversion value or efficiency, or to maximize blockchain utilization, or both.

As an example of generating quantitative content (e.g., predictions for various times) and qualitative content (e.g., suggestions or recommendations) for a notification, the follow table illustrates output of a notice generator (e.g., the AI 700, or the platform based on output from the AI 700). In this embodiment, the notice generator may generate a notification by comparing predictions from the AI engine 700 to details (each a “Standard”) from the commission and/or the client policy profile.

| | | | Time for which |
|---|---|---|---|
| | Prediction by AI engine | | prediction is |
| No. | 700 | Standard | targeted |
| 1A | Predicted exchange rate | Exchange rate 1 | Contemporaneous |
| | from Fiat 1 to Crypto 1 | specified in | with time of |
| | | commission or policy | prediction |
| | | profile | |
| 1B | Predicted exchange rate | Exchange rate 1 | One minute after |
| | from Fiat 1 to Crypto 1 | specified in | prediction is |
| | | commission or policy | generated |
| | | profile | |
| 1C | Predicted exchange rate | Exchange rate 1 | Two minutes after |
| | from Fiat 1 to Crypto 1 | specified in | prediction is |
| | | commission or policy | generated |
| | | profile | |
| 1D | Predicted exchange rate | Exchange rate 1 | Ten minutes after |
| | from Fiat 1 to Crypto 1 | specified in | prediction is |
| | | commission or policy | generated |
| | | profile | |
| 1E | Predicted exchange rate | Exchange rate 1 | One hour after |
| | from Fiat 1 to Crypto 1 | specified in | prediction is |
| | | commission or policy | generated |
| | | profile | |
| 1F | Predicted exchange rate | Exchange rate 1 | Two hours after |
| | from Fiat 1 to Crypto 1 | specified in | prediction is |
| | | commission or policy | generated |
| | | profile | |
| 1G | Predicted exchange rate | Exchange rate 1 | 24 hours after |
| | from Fiat 1 to Crypto 1 | specified in | prediction is |
| | | commission or policy | generated |
| | | profile | |
| 1H | Predicted exchange rate | Exchange rate 1 | Upon occurrence of |
| | from Fiat 1 to Crypto 1 | specified in | specified future |
| | | commission or policy | event with known |
| | | profile | time of occurrence |
| | | | (e.g., opening of a |
| | | | specified market) |
| 2A | Predicted exchange rate | Exchange rate 2 | Contemporaneous |
| | from Crypto 1 to Fiat 2 | specified in | with time of |
| | | commission or policy | prediction |
| | | profile | |
| 2B | Predicted exchange rate | Exchange rate 2 | One minute after |
| | from Crypto 1 to Fiat 2 | specified in | prediction is |
| | | commission or policy | generated |
| | | profile | |
| 2C | Predicted exchange rate | Exchange rate 2 | Two minutes after |
| | from Crypto 1 to Fiat 2 | specified in | prediction is |
| | | commission or policy | generated |
| | | profile | |
| 2D | Predicted exchange rate | Exchange rate 2 | Ten minutes after |
| | | | prediction is |
| | from Crypto 1 to Fiat 2 | specified in | generated |
| | | commission or policy | |
| | | profile | |
| 2E | Predicted exchange rate | Exchange rate 2 | One hour after |
| | from Crypto 1 to Fiat 2 | specified in | prediction is |
| | | commission or policy | generated |
| | | profile | |
| 2F | Predicted exchange rate | Exchange rate 2 | Two hours after |
| | | specified in | |
| | from Crypto 1 to Fiat 2 | commission or policy | prediction is |
| | | profile | generated |
| 2G | Predicted exchange rate | Exchange rate 2 | 24 hours after |
| | from Crypto 1 to Fiat 2 | specified in | prediction is |
| | | commission or policy | generated |
| | | profile | |
| 2H | Predicted exchange rate | Exchange rate 2 | Upon occurrence of |
| | | specified in | |
| | from Crypto 1 to Fiat 2 | commission or policy | specified future |
| | | profile | event with known |
| | | | time of occurrence |
| | | | (e.g., opening of a |
| | | | specified market) |
| 3A | Predicted transaction | Acceptable | Contemporaneous |
| | costs | transaction costs | with time of |
| | | specified in | prediction |
| | | commission or policy | |
| | | profile | |
| 3B | Predicted transaction | Acceptable | One minute after |
| | costs | transaction costs | prediction is |
| | | specified in | generated |
| | | commission or policy | |
| | | profile | |
| 3C | Predicted transaction | Acceptable | Two minutes after |
| | costs | transaction costs | prediction is |
| | | specified in | generated |
| | | commission or policy | |
| | | profile | |
| 3D | Predicted transaction | Acceptable | Ten minutes after |
| | costs | transaction costs | prediction is |
| | | specified in | generated |
| | | commission or policy | |
| | | profile | |
| 3E | Predicted transaction | Acceptable | One hour after |
| | costs | transaction costs | prediction is |
| | | specified in | generated |
| | | commission or policy | |
| | | profile | |
| 3F | Predicted transaction | Acceptable | Two hours after |
| | costs | transaction costs | prediction is |
| | | specified in | generated |
| | | commission or policy | |
| | | profile | |
| 3G | Predicted transaction | Acceptable | 24 hours after |
| | costs | transaction costs | prediction is |
| | | specified in | generated |
| | | commission or policy | |
| | | profile | |
| 3H | Predicted transaction | Acceptable | Upon occurrence of |
| | costs | transaction costs | specified future |
| | | specified in | event with known |
| | | commission or policy | time of occurrence |
| | | profile | (e.g., opening of a |
| | | | specified market) |

A comparison of a prediction to a standard may be used to determine a qualitative notification to a user. For example, if an assessment of a potential transaction is performed contemporaneous with time of prediction (e.g., Predicted exchange rate from Fiat 1 to Crypto 1; or Predicted exchange rate from Crypto 1 to Fiat 2; or Predicted transaction costs) and the prediction fails to meet the specified standard, the notification may simply state that the platform does not recommend immediate execution the transaction.

Some embodiments determine a trend based on predictions over several different times. For example, if an assessment of a potential transaction is performed contemporaneous with time of prediction and fails to meet the specified standard, but predictions for future times show one or more of the predictions trending in a favorable direction (e.g., one or more exchange rates are predicted to rise over the time frame of the predictions), the notification may state that the platform does not recommend immediate execution the transaction, but that trends for one or more factors look favorable and that the user should check again later (and may present a description or graph of one or more predictions), or should execute the transaction at a suggested future time.

Alternatively, if an assessment of a potential transaction is performed contemporaneous with time of prediction and fails to meet the specified standard, and predictions for future times show one or more of the predictions trending in an unfavorable direction (e.g., one or more exchange rates are predicted to fall over the time frame of the predictions), the notification may state that the platform recommends immediate execution the transaction in order to avoid the risk that such trends present to the user's desired outcome.

Illustrative embodiments predict exchange rates from Fiat 1 to each of a plurality of cryptocurrencies (e.g., Crypto 1, Crypto 2; Crypto 3), and/or predict exchange rates from each of a plurality of cryptocurrencies to Fiat 2, and/or predict transaction costs (e.g., GAS costs for each of a plurality of crypto exchanges; transactions for each of a plurality of potential transaction speeds) for a contemporaneous time, or a plurality of future times. Using such predictions, the platform 100 may suggest to a user which of the plurality of cryptocurrencies to use as an intermediate currency, may suggest to a user a cryptocurrency exchange; and/or may suggest to the user a transaction speed, respectively.

In illustrative embodiments, the artificial intelligence engine 700 is driven in part by transaction details 730, as included in the commission. For example, the artificial intelligence engine 700 may base its predictions and assessment on the transaction speed specified by the initiator 110.

FIG. 7B is a flow chart illustrating an embodiment of a method 750 of operation of an artificial intelligence engine 700.

Step 752 includes configuring the artificial intelligence engine 700. In illustrative embodiments, the artificial intelligence engine 700 is configured through training performed by the platform 100, or by a platform operator. In illustrative embodiments, the artificial intelligence engine 700 is fully configured, and the configuration is fixed, before the artificial intelligence engine 700 is deployed on the platform 100 to facilitate transactions.

Step 754 includes obtaining, or accessing, input data, such as client policy profile 710, market conditions 720, and transaction data 730.

Step 756 includes generating, based on the input data, quantitative predictions of future currency exchange rates. Such prediction may include prediction 740 of future currency exchange rates for a specified fiat currency, a plurality of fiat currencies, a specified cryptocurrency, and/or a plurality of cryptocurrencies. Moreover, such predictions may be for a future point in time measured in second, minutes, hours, or days from the time the prediction is generated by the artificial intelligence engine 700. Such predictions may also include predictions of transaction costs 742 corresponding to the proposed transaction and/or predicted exchange rates. Transaction costs 742 may include, for example, platform fees charged by the platform 11 for execution of a commission. Transaction costs 742 may include, for example, gas costs (as that term is known in the crypto exchange arts). Gas cost varies based upon global utilization and Origin/Destination cryptocurrency exchanges. Each such exchange has a predetermined number of Blockchain Approvals (e.g. from 9-30). This drives cost calculations or Network Fees. Speed of a cryptocurrency exchange network requires more Gas (e.g. costs more) and is faster as the approvers on the Blockchain or “Network” are being paid more to prioritize the transaction in question (e.g., making it process faster).

Step 756 may also include, suggestions 744 for a set of one or more cryptocurrencies to use in executing the transaction, each suggestion corresponding to the predicted exchange rates.

Step 758 includes generating a qualitative assessment of a proposed transaction based, at least in part, on the predictions of future currency exchange rates. Such a qualitative assessment may be generated by, for example, comparing a quantitative prediction (e.g., from artificial intelligence engine 700) against corresponding information specified in the commission or in a corresponding policy profile. For example, a desired minimum exchange rate specified in a commission or policy profile may be compared to one or more predictions of future exchange rate produced by the artificial intelligence engine 700, and a qualitative assessment may be produced (by the artificial intelligence engine 700 or other portions of the platform 100) based on that comparison.

For example, if a predicted exchange rate is less than a desired minimum exchange rate specified in a commission or policy profile, the notification may recommend to the initiator 110 that the initiator not execute the commission at that time, but instead to delay execution of the commission, or to suggest a future time to execute the commission. Such suggested future time may be based on comparison of the desired minimum exchange rate specified in a commission or policy profile against another predicted exchange rate predicted by the artificial intelligence engine 700 for a time further in the future.

For example, if a predicted exchange fees or (“GAS” costs or other “transaction costs”) exceed a desired maximum specified in a commission or policy profile, the notification may recommend to the initiator 110 that the initiator not execute the commission at that time, but instead to delay execution of the commission, or to suggest a future time to execute the commission. Such suggested future time may be based on comparison of the desired maximum transaction costs specified in a commission or policy profile against another predicted transaction cost predicted by the artificial intelligence engine 700 for a time further in the future.

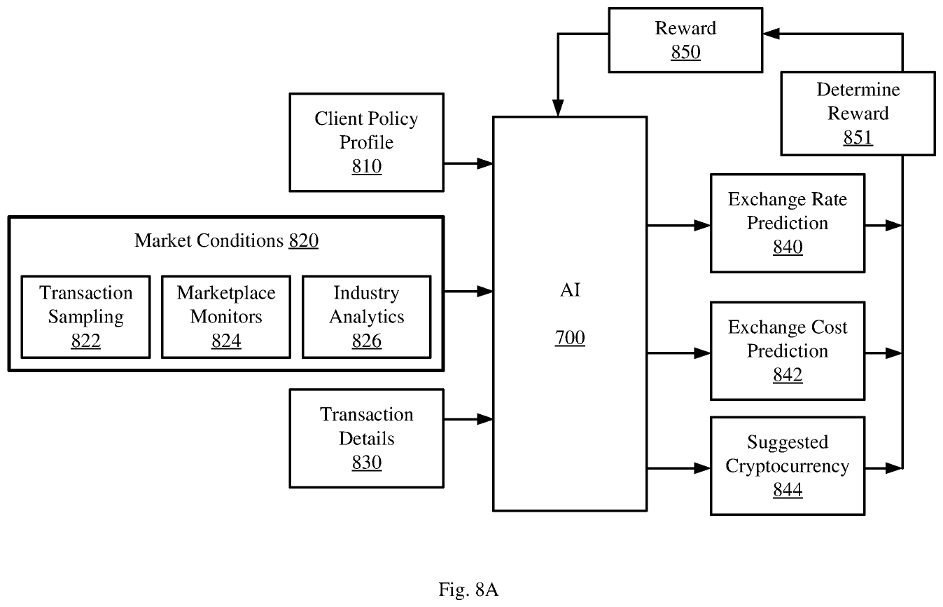

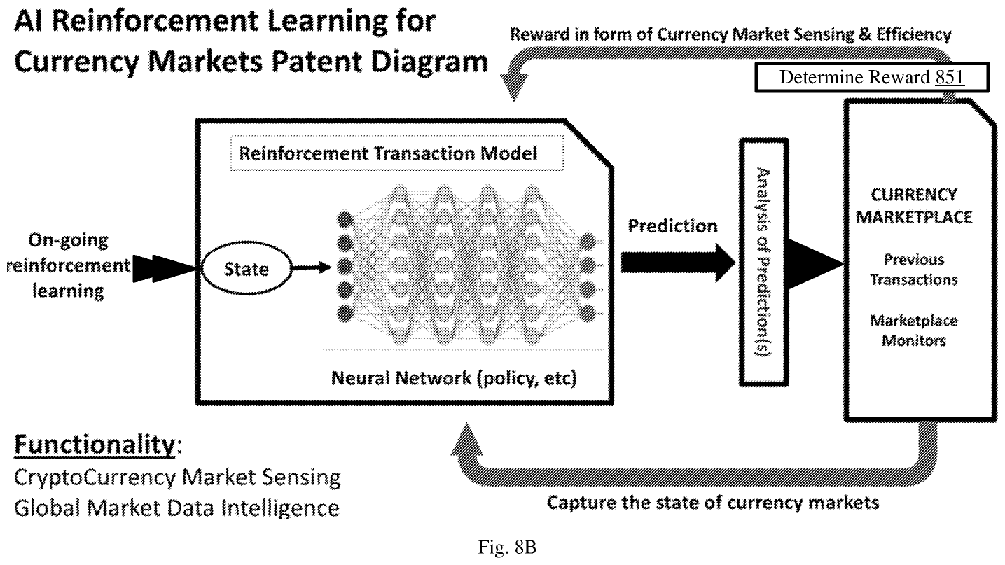

FIG. 8A is a chart illustrating an embodiment of a method of training an artificial intelligence engine.

Training Artificial Intelligence Engine—General

Training an artificial intelligence engine involves presenting to the engine a set of training data, and assessing the output produced by the engine in response to the training data. The training involves adjusting internal parameters of the engine based on that assessment. Typically, as known in the art, adjusting the internal parameters of the engine is performed by the engine itself, for example via reinforcement learning. Such training may include repeating the foregoing process over many iterations until, as known in the art, the engine's designer deems the output produce by the engine to be satisfactory.

In illustrative embodiments, training the artificial intelligence engine 700 employed by the secure platform 100 uses model-based reinforcement learning (“RL”), as schematically illustrated in FIG. 8A. RL is a type of machine learning, which is a type of artificial intelligence.

Generally, RL trains artificial intelligence engines to make a sequence of decisions. An agent is an autonomous or semi-autonomous system that uses learning, such as deep learning, to perform and improve at its tasks. In illustrative embodiments, the artificial intelligence engine includes a neural network. In illustrative embodiments, the neural network includes 10,000 hidden layers. The agent learns to achieve a goal, such as by trial and error, and is incentivized to accomplish that goal based on a rewards and punishment system. The goal is to maximize the total reward. It is up to the model to determine how to perform the task to maximize the reward. The RL process can leverage inputs and trials to determine how to perform the task to maximize the reward.

In illustrative embodiments, model-based reinforcement learning uses a “contact-rich environment” to provide real-time, real-world training data for the ongoing improvement of the performance of the engine. To that end, in illustrative embodiments, RL uses transaction sampling to improve target value estimates in currency exchange training models; and increases temporal difference learning when applied to currency-based decisions. A primary value of this is to enable the use of real-time market triggers to optimize the timing of currency exchange transactions and related business decisions.

Training Artificial Intelligence Engine—Details

An element to illustrative embodiments is a methodology for modelling real-time currency exchange data for the purposes of providing faster better intelligence when used in overall financial risk management.

As described below, the RL training employs a variety of data and data types.

Client Policy Profile

Training the artificial intelligence engine 700 includes (unlike a bank) a client policy profile to permit the client to drive the reward policy of the RL model. The reward policy can be established by the designer of the model or by a client establishing different policies or requesting different outputs, such as with a policy profile. The model can incorporate the reward policy to provide predictions.

The client, such as Company A, can create a policy profile. The policy profile can include one or more conditions that the client is willing to accept or goals for which the client prefers be accomplished.

The conditions of the policy profile when selected by the client, updated by the client, changed by the client, or weighted by the client can change the weightings of the parameters consumed by the artificial intelligence engine 700 used to provide a prediction. The one or more conditions can include the amount of risk the client is willing to accept (e.g., risk that exchange rates for one or more currency exchange steps will change in an unfavorable direction), the type or amount of financial return required or preferred by the client (e.g., a minimum desired exchange rate for one or more currency exchanges), the amount of cost to the client (e.g., risk that transaction costs will change in an unfavorable direction), the acceptable transaction time (e.g., risk that delay in executing a proposed transaction will result in an inability to executed the transaction in an acceptable transaction time), or the like.

In some embodiments, configuring the artificial intelligence engine includes configuring the artificial intelligence engine 700 by reinforcement learning (“RL”) according to the client policy profile, the client policy profile specifying a reward policy for the reinforcement learning, the reward policy specifying at least one of: a set of goals desired by the client; and/or a set of conditions specified by the client for a currency transaction.

Platform AI

In the secure platform, RL uses historical market conditions 820, including transaction sampling 822 and marketplace monitors 824, to improve target value estimates in currency exchange training models. The RL process can also use industry analytics 826 including global supply chain trends, trends, and the like.

The transaction sampling draws from previous transactions that occurred on the secure platform 100. The data, which is trusted but anonymized, provides for a unique and specialized source as the data generated by a first set of transactions can be used to advise on and drive subsequent transactions. The data from previous transactions can include:
1) When the transaction was done?
2) Who was the distributing party?
3) Who was the recipient?
4) Financial details of the transaction (e.g., amount distributed, starting currency, ending currency, speed of transaction requested, actual speed of transaction, exchange used, currency exchange rate, or the like)

Marketplace Monitors

The marketplace monitors 824 include data associated with crypto-to-crypto currency conversion, crypto-to-fiat currency conversion, fiat-to-fiat currency conversion, and blockchain confirmation cost and execution timing. In illustrative embodiments, such data being evaluated relates to:
(a) quantitative data describing Crypto to Crypto exchanges, such as rate of exchange, costs related to exchange, and global trading volume(s);
(b) quantitative data describing Crypto to Fiat exchanges, such as rate of exchange, costs related to exchange, global daily liquidity volume(s);
(c) quantitative data describing Fiat to Fiat exchanges, such as rate of exchange, costs related to exchange, global daily liquidity volume(s);
(d) Blockchain Costs=transaction confirmation time(s), costs and cost fluctuation trends related to transaction confirmations, number of transaction confirmations required by each global exchange.

Various embodiments may be characterized by the potential claims listed in the paragraphs following this paragraph (and before the actual claims provided at the end of this application). These potential claims form a part of the written description of this application. Accordingly, subject matter of the following potential claims may be presented as actual claims in later proceedings involving this application or any application claiming priority based on this application. Inclusion of such potential claims should not be construed to mean that the actual claims do not cover the subject matter of the potential claims. Thus, a decision to not present these potential claims in later proceedings should not be construed as a donation of the subject matter to the public.

Accordingly, in some embodiments, training (or configuring) an artificial intelligence engine 700 include providing one or more training data sets, receiving one or more outputs of the artificial intelligence engine 700; assessing the received outputs of the artificial intelligence engine 700, and providing to the artificial intelligence engine 700, based on the one or more outputs, a reward 850 according to a reward policy. In illustrative embodiments, the reward policy specifies at least one of: a set of goals desired by the client; and/or a set of conditions specified by the client for a currency transaction.

In illustrative embodiments, a set of conditions includes any one or more of: an amount of risk the client is willing to accept in the currency exchange transaction; a type of financial return desired by the client in the currency exchange transaction; an amount of financial return desired by the client in the currency exchange transaction; a cost of the currency exchange transaction acceptable to the client; and/or a completion deadline for the currency exchange transaction; a transaction duration, for the currency exchange transaction, acceptable to the client.

In ways known in the art, the artificial intelligence engine 700 processes the reward 850 to refine the artificial intelligence engine 700 (e.g., refine a neural network that is part of the artificial intelligence engine 700). The foregoing process may be iterative in that it may be repeated until the outputs of the artificial intelligence engine 700 are sufficiently accurate, as determined by the designer of the artificial intelligence engine 700 for the purposes described herein.

In illustrative embodiments, the training sets include one or more of, or any combination of one or more of, information from the client policy profile 810; market conditions 820, and/or transaction details 830

Information from the client policy profile may include, for example, a desired or minimum acceptable exchange rate; a desired or maximum acceptable transaction speed, to name but a few examples.

Market conditions 820 may include information from transaction sampling 822, information from marketplace monitoring 824, and/or information from industry analytics 826.

Information from transaction sampling 822 may include information sampled from previous transactions executed by the platform 100. Such information may include, for example, one or more of the following, in any combination: 1) When the transaction was done?; 2) Who was the distributing party (i.e., the party that is the source of funds, and what industry the distributing party is a part of); 3) Who was the recipient (i.e. what industry to recipient party is a part of); 3b) What Geography both Distributing party and Recipient parties are located; 4) Financial details of the transaction (e.g., amount distributed, starting currency, ending currency, speed of transaction requested, actual speed of transaction, actual Network fee cost (i.e., blockchain and Exchange fees) exchange used, currency exchange rate, or the like, Cryptocurrency used, Exchange rate of Cryptocurrency at time of transaction); 5) What fees the platform 100 realized for its proprietor.

Information from marketplace monitoring 824 includes, generally, information that captures the state of currency markets. Information from marketplace monitoring 824 may include for example, one or more fiat to cryptocurrency exchange rates for each of a plurality of fiat currency to cryptocurrency pairs. Information from marketplace monitoring 824 may also include for example, present market fees, such as fees charged by the platform 100 (“platform fees”) 481, and/or fees charged by the cryptocurrency exchange (“exchange fees”) 483.

Information from industry analytics 826 may include for example, one or more of the following, in any combination: (a) quantitative data describing Crypto to Crypto exchanges, such as rate of exchange, costs related to exchange, and global trading volume(s); (b) quantitative data describing Crypto to Fiat exchanges, such as rate of exchange, costs related to exchange, global daily liquidity volume(s); (c) quantitative data describing Fiat to Fiat exchanges, such as rate of exchange, costs related to exchange, global daily liquidity volume(s); and/or (d) Blockchain Costs: transaction confirmation time(s) costs and cost fluctuation trends related to transaction confirmations, number of transaction confirmations required by each global exchange.

Outputs from the artificial intelligence engine 700 include, for example, predictions 840 of future exchange rates for one or more fiat-to-cryptocurrency exchanges. Such predictions may be for one or more future times, including seconds, minutes, hours, or days into the future as measured from the time of the prediction.

Outputs from the artificial intelligence engine 700 include, for example, predictions 842 of future GAS costs, including predictions of transaction fees as described above.

Outputs from the artificial intelligence engine 700 include, for example, a suggestion 844 of one or more cryptocurrencies for use in the exchange transaction.

Analysis of the output predictions 840 and/or 842 and/or 844, and specification 851 of the reward 850 may be performed by a human designer, or by the platform 100.

Without limitation, potential subject matter that may be claimed (prefaced with the letter “P” so as to avoid confusion with the actual claims presented below) includes:

P1. A method of controlling a currency exchange transaction, the method including:
accessing a secure exchange platform;
providing, to the secure exchange platform, parameters of a proposed currency exchange transaction;
reviewing a commission produced by the secure exchange platform, the commission defining an agreed currency exchange transaction between an initiator and a recipient, the agreed currency exchange transaction including (i) accessing, by the secure exchange platform, funds of the initiator defined in a first fiat currency (“initiator funds”); (ii) causing exchange of the initiator funds into a cryptocurrency (“crypto funds”) by a first crypto exchange process; and (iii) causing exchange of the crypto funds by a second crypto exchange process into funds denominated in a second fiat currency (“recipient funds”), the second fiat currency being different than the first fiat currency; and (iv) securing the recipient funds in an account; and
causing the secure exchange platform to execute the agreed currency exchange transaction.

P2. The method of P1, wherein the account is controlled by the initiator.

P3. The method of P1, wherein the account is controlled by, or at least accessible to, the recipient.

P4. The method of P1, wherein accessing, by the secure exchange platform, funds of the initiator defined in first fiat currency, includes accessing by the secure exchange platform funds in an account controlled by the initiator.

P5: The method of P1, wherein:
accessing, by the secure exchange platform, funds of the initiator defined in a first fiat currency, includes accessing by the secure exchange platform initiator funds in an account controlled by the initiator; and
at no point thereafter are the initiator funds or recipient funds in another account, which other account is under control of the secure exchange platform.

P11: A computer-implemented method for user-controlled currency conversion, the method including:
obtaining, by a currency exchange platform, a commission for currency exchange between parties, the parties including a funding party (“first party”) and a set of recipient parties (each a “recipient party” or a “second party”), the commission including transaction data defining a proposed transaction;
obtaining, by the currency exchange platform, access to source funds from the funding party, the source funds denominated in a source fiat currency;
receiving from a one of the parties (the “commencing party”), an instruction to execute the proposed transaction;
executing the proposed currency conversion transaction defined by the commission for currency exchange, said execution comprising:
   converting, in a first conversion process, the source funds from the source fiat currency to a cryptocurrency; and subsequently
   converting, in a second conversion process, the cryptocurrency to recipient funds denominated in a destination fiat currency; and
   causing, by the currency exchange platform, transfer of the recipient funds to a recipient account, which recipient account is under control of the recipient party.

P12: The method of P11 wherein the commission is defined by information received from the first party.

P13: The method of P11 or P12 wherein the commission is defined by information received from the second party.

P14: The method of any of P11-P13, further including providing, to at least one of the parties prior to execution of the proposed currency conversion transaction, a notification comprising an assessment of the proposed currency conversion transaction, the assessment based on currency market predictions which currency market predictions are based on at least one of:
(i) a client policy profile;
(ii) the transaction data; and
(iii) current market data.

P15: The method of any of P11-P14, wherein the currency market predictions are based on all of:
(i) a client policy profile;
(ii) the transaction data; and
(iii) current market data.

P16: The method of any of P11-P15, wherein the commencing party is the funding party.

P17: The method of any of P11-P16, wherein the commencing party is a recipient party from the set of recipient parties.

A listing of certain reference numbers is presented below.
100: Secure platform;
110: Initiating party;
111: Initiating party bank account;
112: Initiating party exchange account;
113: Initiating party control of initiating party bank account;
114: Initiating party control of initiating party exchange account;
115: Funds flow between initiating party bank account and initiating party exchange account;
120: Recipient;
121: Recipient bank account;
122: Recipient exchange account; \ 123: Recipient control of recipient bank account;
124: Recipient control of recipient exchange account;
125: Funds flow between recipient bank account and recipient exchange account;
130: Set of third parties;
141: Order;
151: Platform limited control of funds in initiator exchange account;
152: Platform limited control of funds in initiator bank account;
156: Communications link between initiator and platform;
157: Communications link between platform and recipient;
158: Funds flow from initiator to recipient;
401: Onboarding dashboard;
700: Artificial intelligence engine;
710: Client policy profile;
720: Current market conditions; 730: Transaction details;
740: Set of currency exchange predictions;
742: Set of transaction cost predictions;
744: Set of suggested cryptocurrencies;
810: Client policy profile training set;
820: Market conditions training set;
822: Transaction sampling training set;
824: Marketplace monitors training set;
826: Industry analytics training set;
830: Past transaction sampling training set.

Various embodiments of the disclosure may be implemented at least in part on or using a computer, including for example, in any conventional computer programming language. For example, some embodiments may be implemented in a procedural programming language (e.g., “C”), or in an object-oriented programming language (e.g., “C++”). Other embodiments may be implemented as preprogrammed hardware elements (e.g., application specific integrated circuits, FPGAs, and digital signal processors), or other related components.

In an alternative embodiment, the disclosed apparatus and methods may be implemented as a computer program product for use with a computer system. Such implementation may include a series of computer instructions fixed either on a tangible medium, such as a non-transient computer readable medium (e.g., a diskette, CD-ROM, ROM, FLASH memory, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments may be implemented as a combination of both software (e.g., a computer program product) and hardware. Still other embodiments are implemented as entirely hardware, or entirely software.

Computer program logic implementing all or part of the functionality previously described herein may be executed at different times on a single processor (e.g., concurrently) or may be executed at the same or different times on multiple processors and may run under a single operating system process/thread or under different operating system processes/threads. Thus, the term “computer process” refers generally to the execution of a set of computer program instructions regardless of whether different computer processes are executed on the same or different processors and regardless of whether different computer processes run under the same operating system process/thread or different operating system processes/threads.

The embodiments of the disclosure described above are intended to be merely exemplary; numerous variations and modifications will be apparent to those skilled in the art. All such variations and modifications are intended to be within the scope of the present disclosure as defined in any appended claims.

What is claimed is:

1. A computer-implemented method for user-controlled currency conversion, the method comprising:
obtaining, by a currency exchange platform, a commission for currency exchange between an initiator party and a recipient party, the commission comprising transaction data defining a proposed transaction;
obtaining, by the currency exchange platform, access to source funds from the initiator, the source funds denominated in a source fiat currency;
providing, to the initiator party prior to execution of the proposed currency conversion transaction, a notification comprising an assessment of the proposed currency conversion transaction, the assessment based on currency market predictions which currency market predictions are based on:
(i) a client policy profile;
(ii) the transaction data; and
(iii) current market data;
receiving from the initiator party, subsequent to the receipt by the initiator party of the notification, an instruction to execute the proposed transaction;
executing the proposed currency conversion transaction defined by the commission for currency exchange, said execution comprising:
converting, in a first conversion process, the source funds from the source fiat currency to a cryptocurrency; and subsequently
converting, in a second conversion process, the cryptocurrency to recipient funds denominated in a destination fiat currency; and
causing, by the currency exchange platform, transfer of the recipient funds to a recipient account, which recipient account is under control of the recipient party.

2. The computer-implemented method of claim 1, wherein:
the currency exchange platform recommends the cryptocurrency based on a combination of the source fiat currency and the destination fiat currency prior to executing the currency conversion transaction.

3. The computer-implemented method of claim 1, wherein:
the currency exchange platform obtains access to the source funds from the initiator at a first time; and
the currency exchange platform causes the transfer of the recipient funds to a recipient account at a second time subsequent to the first time; and wherein
the source funds and the recipient funds are not held in an account of the currency exchange platform at any point in time between the first time and the second time.

4. The computer-implemented method of claim 1, further comprising, after obtaining the commission for currency exchange and prior to obtaining access to source funds from the initiator:
sending, by the currency exchange platform, the commission to the recipient party for review;
subsequently receiving, by the currency exchange platform from the recipient party, approval of the commission; and
notifying, by the currency exchange platform, the initiator party that the recipient party has approved of the commission.

5. The computer-implemented method of claim 1, wherein obtaining the commission for currency exchange comprises:
receiving, at the currency exchange platform, currency transaction information defining payment from the initiator to the recipient; and
defining, by the currency exchange platform and based on the currency transaction information, the commission for currency exchange.

6. The computer-implemented method of claim 5, wherein receiving currency transaction information comprises receiving:
specification of the source fiat currency;
specification of a source amount denominated in the source fiat currency;
specification of the cryptocurrency;
specification of a source account holding the source funds;
specification of a destination fiat currency;
specification of the recipient account for receiving converted currency;
specification of a crypto exchange;
specification of a specified transaction speed; and/or
specification of a specified time to send the commission to a recipient party.

7. The computer-implemented method of claim 1 further comprising, prior to executing the first conversion process:
delaying the first conversion process; and subsequently
receiving from the initiator an instruction to initiate execution of the first conversion process.

8. The computer-implemented method of claim 1 further comprising, prior to executing the first conversion process:
generating, by the currency exchange platform, a notification to the initiator, the notification:
comprising an assessment of the proposed user-controlled currency conversion transaction; and
requesting from the initiator instructions to initiate execution of the currency conversion transaction.

9. The computer-implemented method of claim 8, wherein:
the notification is generated by an artificial intelligence based on at least one of market conditions, or conditions of the commission; and
the assessment comprises a qualitative assessment of the outcome of the currency transaction if the currency transaction were to be executed at the time indicated by the notification.

10. The computer-implemented method of claim 8, wherein:
the notification is generated by an artificial intelligence based on at least one of market conditions, or conditions of the commission; and
the assessment comprises a recommendation of a point in time at which the currency transaction would be more beneficial for the initiator.

11. A computer-implemented artificial intelligence system comprising:
an input configured to receive:
(a) transaction data from a user, the transaction data defining a proposed user-controlled currency conversion transaction; and
(b) current market data of a currency exchange market;
an artificial intelligence configured to generate a set of real-time currency market predictions, the set of currency market predictions based on:
(i) a client policy profile;
(ii) the transaction data; and
(iii) the current market data;
an automated processor configured to produce, prior to execution of the currency conversion transaction and based on the currency market predictions, a notification comprising an assessment of the proposed user-controlled currency conversion transaction; and
an output configured to provide the notification to a user.

12. The apparatus of claim 11, further comprising a user interface configured to receive, prior to execution of the currency conversion transaction, user input to the artificial intelligence, the user input comprising one or more of:
an amount of risk the client is willing to accept in the currency exchange transaction;
a type of financial return desired by the client in the currency exchange transaction;
an amount of financial return desired by the client in the currency exchange transaction;
a cost of the currency exchange transaction acceptable to the client;
a completion deadline for the currency exchange transaction; and/or
a transaction duration, for the currency exchange transaction, acceptable to the client.

13. The apparatus of claim 11, wherein the artificial intelligence is further configured to generate the set of real-time currency market predictions based on:
(iv) transaction sampled data from prior currency exchange translations executed using the apparatus.

14. The apparatus of claim 11, wherein the automatically-implemented artificial intelligence is configured by reinforcement learning (“RL”) according to the client policy profile, the client policy profile specifying a reward policy for the reinforcement learning, the reward policy specifying at least one of:
a set of goals desired by the client; and/or
a set of conditions specified by the client for a currency transaction.

15. The apparatus of claim 14, wherein the set of conditions comprises one or more of:
an amount of risk the client is willing to accept in the currency exchange transaction;
a type of financial return desired by the client in the currency exchange transaction;
an amount of financial return desired by the client in the currency exchange transaction;
a cost of the currency exchange transaction acceptable to the client; and/or
a completion deadline for the currency exchange transaction;
a transaction duration, for the currency exchange transaction, acceptable to the client.

16. The apparatus of claim 11, further comprising a user interface configured to receive, from the user, instructions regarding whether to execute the currency exchange transaction.

17. The apparatus of claim 16, wherein:
the notification includes a proposed execution timing; and
the user interface is further configured to receive, from the user, instructions regarding when at a future point to execute the currency exchange transaction.

18. The apparatus of claim 11, wherein the currency exchange platform is further configured to generate a notification to the user, the notification:
comprising an assessment of the proposed user-controlled currency conversion transaction; and
requesting from the initiator instructions to initiate execution of the currency conversion transaction.

19. The apparatus of claim 11, wherein the currency exchange platform is further configured to generate a notification to the user, wherein:
the notification is generated by the artificial intelligence based on at least one of current market data, or conditions of a commission defining the controlled currency conversion transaction; and
the notification comprises a qualitative assessment of the outcome of the currency conversion transaction if the currency conversion transaction were to be executed at a time indicated by the notification.

20. The apparatus of claim 19, wherein the qualitative assessment of the outcome of the currency transaction comprises a statement that one or more exchange rates are not to the user's benefit pursuant to the client policy profile.
